(19) United States
(12) Patent Application Publication
(10) Pub. No.: US 2022/0312502 A1
(43) Pub. Date: Sep. 29, 2022

(54) METHOD AND APPARATUS FOR SMALL DATA TRANSMISSION AND RECEPTION IN MOBILE COMMUNICATION SYSTEM

(71) Applicant: ELECTRONICS AND TELECOMMUNICATIONS RESEARCH INSTITUTE, Daejeon (KR)

(72) Inventor: Jae Heung Kim, Daejeon (KR)

(73) Assignee: ELECTRONICS AND TELECOMMUNICATIONS RESEARCH INSTITUTE, Daejeon (KR)

(21) Appl. No.: 17/703,952

(22) Filed: Mar. 24, 2022

(30) Foreign Application Priority Data
Mar. 26, 2021 (KR) 10-2021-0039662
May 10, 2021 (KR) 10-2021-0060300
Mar. 18, 2022 (KR) 10-2022-0033854

(51) Int. Cl. H04W 74/08; H04W 74/00; H04W 72/04; H04W 72/14; H04W 72/12; H04W 76/19

(52) U.S. Cl. CPC H04W 74/0841; H04W 74/002; H04W 74/0866; H04W 72/044; H04W 72/14; H04W 72/1263; H04W 76/19

(57) ABSTRACT

An operation method for non-SDT, performed by a terminal, may comprise: initiating or triggering an SDT operation with a base station; identifying occurrence of a non-SDT packet in a state in which the SDT operation is initiated or triggered; determining whether a condition for performing transmission of the non-SDT packet is satisfied when the occurrence of the non-SDT packet is identified; and in response to determining that the condition is satisfied, performing the transmission of the non-SDT packet.

### CROSS-REFERENCE TO RELATED APPLICATIONS

This application claims priority to Korean Patent Applications No. 10-2021-0039662 filed on Mar. 26, 2021, No. 10-2021-0060300 filed on May 10, 2021, and No. 10-2022-0033854 filed on Mar. 18, 2022, with the Korean Intellectual Property Office (KIPO), the entire contents of which are hereby incorporated by reference.

### BACKGROUND

### 1. Technical Field

The present disclosure relates to a method and an apparatus for transmitting and receiving an uplink data packet, and more particularly, to a method and an apparatus for transmitting and receiving a non-small data transmission (SDT) packet occurring while performing an SDT operation occurring intermittently.

### 2. Related Art

In order to cope with the rapidly increasing wireless data, a mobile communication system considers a transmission frequency band of 6 GHz to 90 GHz for a wide system bandwidth. In such a high frequency range, a small base station is assumed due to deterioration of reception signal performance due to path loss and reflection of radio waves.

In order to deploy a mobile communication system based on small base stations having small service coverages in consideration of the millimeter wave frequency band of 6 GHz to 90 GHz, a functional split method in which functions of a base station are configured as being split into a plurality of remote radio transmission and reception blocks and one centralized baseband processing block may be applied instead of deploying small base stations in which all of radio protocol functions of the mobile communication system are implemented. In addition, a method of configuring the mobile communication system by utilizing a plurality of transmission and reception points (TRPs) using functions such as a carrier aggregation, dual connectivity, duplication transmission, and the like may be considered.

In a mobile communication system to which such the functional split function, bi-casting function, or duplication transmission function is applied, radio resource allocation methods and control signaling methods for transmission/reception of intermittently occurring small data transmission (SDT) packets are required.

### SUMMARY

Accordingly, exemplary embodiments of the present disclosure are directed to providing an operation method of a terminal for transmitting a non-SDT packet occurring after an SDT operation is initiated.

Accordingly, exemplary embodiments of the present disclosure are also directed to providing an operation method of a base station for receiving a non-SDT packet occurring after an SDT operation is initiated.

Accordingly, exemplary embodiments of the present disclosure are also directed to providing a configuration of a terminal apparatus for transmitting an SDT packet and a non-SDT packet.

According to a first exemplary embodiment of the present disclosure, an operation method for non-small data transmission (non-SDT), performed by a terminal, may comprise: initiating or triggering an SDT operation with a base station; identifying occurrence of a non-SDT packet in a state in which the SDT operation is initiated or triggered; determining whether a condition for performing transmission of the non-SDT packet is satisfied when the occurrence of the non-SDT packet is identified; and in response to determining that the condition is satisfied, performing the transmission of the non-SDT packet.

The condition for performing transmission of the non-SDT packet may be determined to be satisfied when a predetermined time elapses from a start time of the initiated or triggered SDT operation; when a time required until the initiated or trigger SDT operation ends or an SDT timer according to the initiated or triggered SDT operation expires is longer than a predetermined threshold; when a radio channel deteriorates below a reference condition after the SDT operation is initiated or triggered; or when a condition for allowing the transmission of the non-SDT packet during the SDT operation is satisfied.

The performing of the transmission of the non-SDT packet may comprise: completing the initiated or triggered SDT operation; transitioning to a connected state with the base station by performing a radio resource control (RRC) restart procedure or an RRC resume procedure with the base station; and performing the transmission of the non-SDT packet by using an uplink resource allocated from the base station.

The performing of the transmission of the non-SDT packet may comprise notifying the base station of the occurrence of the non-SDT packet by using an uplink resource obtained through the initiated or triggered SDT operation, wherein the uplink resource obtained through the initiated or triggered SDT operation is an uplink resource obtained by a random access (RA) procedure with the base station or a configured grant (CG) resource.

In the notifying the base station of the occurrence of the non-SDT packet, the terminal may transmit non-SDT indication information to the base station through a medium access control (MAC) layer control message or RRC layer control message, the non-SDT indication information notifying the occurrence of the non-SDT packet.

When the non-SDT indication information is transmitted through a MAC control element (CE), the non-SDT indication information may be transmitted by being multiplexed with the non-SDT packet or transmitted alone, and a logical channel identifier (LCID) for identifying the non-SDT indication information may be configured.

When the non-SDT indication information is transmitted through an RRC layer control message, the non-SDT indication information may be transmitted through a common control channel (CCCH) or a dedicated control channel (DCCH), and the non-SDT indication information may include an identifier of the terminal and a cause value indicating the transmission of the non-SDT packet.

The performing of the transmission of the non-SDT packet may comprise: early terminating or suspending the initiated or triggered SDT operation; and performing the transmission of the non-SDT packet by using an uplink resource obtained in the initiated or triggered SDT operation.

The performing of the transmission of the non-SDT packet may comprise: transitioning to a connected state with the base station by performing an RRC restart procedure or an RRC resume procedure with the base station while performing the initiated or triggered SDT operation; and after transitioning to the connected state, performing the initiated or triggered SDT operation and the transmission of the non-SDT packet together in the connected state.

According to a second exemplary embodiment of the present disclosure, an operation method for receiving a non-small data transmission (non-SDT) packet, performed by a base station, may comprise: initiating or triggering an SDT operation with a terminal; identifying occurrence of a non-SDT packet in the terminal in a state in which the SDT operation is initiated or triggered; determining whether a condition for performing reception of the non-SDT packet is satisfied when the occurrence of the non-SDT packet is identified; and in response to determining that the condition is satisfied, performing the reception of the non-SDT packet.

The condition for performing reception of the non-SDT packet may be determined to be satisfied when a predetermined time elapses from a start time of the initiated or triggered SDT operation; when a time required until the initiated or trigger SDT operation ends or an SDT timer according to the initiated or triggered SDT operation expires is longer than a predetermined threshold; when a radio channel deteriorates below a reference condition after the SDT operation is initiated or triggered; or when a condition for allowing the transmission of the non-SDT packet during the SDT operation is satisfied.

The performing of the reception of the non-SDT packet may comprise: completing the initiated or triggered SDT operation; transitioning the terminal to a connected state by performing a radio resource control (RRC) restart procedure or an RRC resume procedure with the terminal; and performing the reception of the non-SDT packet by transmitting scheduling information of an uplink resource to the terminal.

The performing of the reception of the non-SDT packet may comprise receiving, from the terminal, non-SDT indication information notifying the occurrence of the non-SDT packet by using an uplink resource allocated to the terminal through the initiated or triggered SDT operation, wherein the uplink resource allocated to the terminal through the initiated or triggered SDT operation is an uplink resource allocated to the terminal by a random access (RA) procedure or a configured grant (CG) resource.

The non-SDT indication information may be received from the terminal through a medium access control (MAC) layer control message or radio resource control (RRC) layer control message.

The performing of the reception of the non-SDT packet may comprise: early terminating or suspending the initiated or triggered SDT operation; and performing the reception of the non-SDT packet using an uplink resource allocated to the terminal in the initiated or triggered SDT operation.

The performing of the reception of the non-SDT packet may comprise: transitioning the terminal to a connected state by performing an RRC restart procedure or an RRC resume procedure with the terminal while performing the initiated or triggered SDT operation; and after the terminal is transitioned to the connected state, performing the initiated or triggered SDT operation and the reception of the non-SDT packet together in the connected state.

According to a third exemplary embodiment of the present disclosure, a terminal for performing non-small data transmission (non-SDT) may comprise: a processor; a memory electronically communicating with the processor; and instructions executable by the processor, which are stored in the memory, wherein when executed by the processor, the instructions may cause the terminal to: initiate or trigger an SDT operation with a base station; identify occurrence of a non-SDT packet in a state in which the SDT operation is initiated or triggered; determine whether a condition for performing transmission of the non-SDT packet is satisfied when the occurrence of the non-SDT packet is identified; and in response to determining that the condition is satisfied, perform the transmission of the non-SDT packet.

The condition for performing transmission of the non-SDT packet may be determined to be satisfied when a predetermined time elapses from a start time of the initiated or triggered SDT operation; when a time required until the initiated or trigger SDT operation ends or an SDT timer according to the initiated or triggered SDT operation expires is longer than a predetermined threshold; when a radio channel deteriorates below a reference condition after the SDT operation is initiated or triggered; or when a condition for allowing the transmission of the non-SDT packet during the SDT operation is satisfied.

In the performing of the transmission of the non-SDT packet, the instructions may further cause the terminal to transmit non-SDT indication information notifying the occurrence of the non-SDT packet to the base station by using an uplink resource obtained through the initiated or triggered SDT operation through a medium access control (MAC) layer control message or RRC layer control message, and the uplink resource obtained through the initiated or triggered SDT operation may be an uplink resource obtained by a random access (RA) procedure with the base station or a configured grant (CG) resource.

In the performing of the transmission of the non-SDT packet, the instructions may further cause the terminal to early terminate or suspend the initiated or triggered SDT operation; and perform the transmission of the non-SDT packet by using an uplink resource obtained in the initiated or triggered SDT operation.

Using the exemplary embodiments of the present disclosure, the terminal can efficiently transmit intermittently occurring SDT packets and/or non-SDT packets to the base station in consideration of the operation state of the terminal and available uplink radio resources. In addition, errors that may occur in transmission and reception of the SDT packets and/or non-SDT packets can also be easily overcome, thereby improving the system performance.

### BRIEF DESCRIPTION OF DRAWINGS

FIG. 1 is a conceptual diagram illustrating an exemplary embodiment of a communication system.

FIG. 2 is a block diagram illustrating an exemplary embodiment of a communication node constituting a communication system.

FIG. 3 is a conceptual diagram illustrating another exemplary embodiment of a communication system.

FIG. 4 is a conceptual diagram illustrating an exemplary embodiment of a method of configuring bandwidth parts (BWPs) in a communication system.

FIG. 5 is a conceptual diagram illustrating an exemplary embodiment of operation states of a terminal in a communication system.

FIG. 6 is a sequence chart illustrating a method of transmitting SDT data based on a 4-step random access procedure according to an exemplary embodiment of the present disclosure.

FIG. 7 is a sequence chart illustrating a method of transmitting SDT data based on a 2-step random access procedure according to an exemplary embodiment of the present disclosure.

FIG. 8 is a sequence chart illustrating an SDT method based on an RA procedure and/or a CG resource.

### DETAILED DESCRIPTION OF THE EMBODIMENTS

Embodiments of the present disclosure are disclosed herein. However, specific structural and functional details disclosed herein are merely representative for purposes of describing embodiments of the present disclosure. Thus, embodiments of the present disclosure may be embodied in many alternate forms and should not be construed as limited to embodiments of the present disclosure set forth herein.

Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may mean “at least one of A or B” or “at least one of combinations of one or more of A and B”. Also, in exemplary embodiments of the present disclosure, “one or more of A and B” may mean “one or more of A or B” or “one or more of combinations of one or more of A and B”.

In exemplary embodiments of the present disclosure, “(re)transmission” may mean “transmission”, “retransmission”, or “transmission and retransmission”, “(re)configuration” may mean “configuration”, “reconfiguration”, or “configuration and reconfiguration”, “(re)connection” may mean “connection”, “reconnection”, or “connection and reconnection”, and “(re)access” may mean “access”, “re-access”, or “access and re-access”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof. Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, preferred exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may be used in the same sense as a communication network.

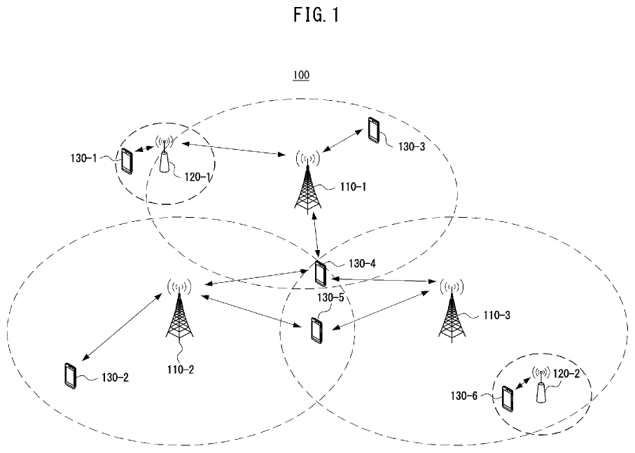

FIG. 1 is a conceptual diagram illustrating an exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes may support 4th generation (4G) communication (e.g., long term evolution (LTE), LTE-advanced (LTE-A)), 5th generation (5G) communication (e.g., new radio (NR)), or the like. The 4G communication may be performed in a frequency band of 6 gigahertz (GHz) or below, and the 5G communication may be performed in a frequency band of 6 GHz or above.

For example, for the 4G and 5G communications, the plurality of communication nodes may support a code division multiple access (CDMA) based communication protocol, a wideband CDMA (WCDMA) based communication protocol, a time division multiple access (TDMA) based communication protocol, a frequency division multiple access (FDMA) based communication protocol, an orthogonal frequency division multiplexing (OFDM) based communication protocol, a filtered OFDM based communication protocol, a cyclic prefix OFDM (CP-OFDM) based communication protocol, a discrete Fourier transform spread OFDM (DFT-s-OFDM) based communication protocol, an orthogonal frequency division multiple access (OFDMA) based communication protocol, a single carrier FDMA (SC-FDMA) based communication protocol, a non-orthogonal multiple access (NOMA) based communication protocol, a generalized frequency division multiplexing (GFDM) based communication protocol, a filter bank multi-carrier (FBMC) based communication protocol, a universal filtered multi-carrier (UFMC) based communication protocol, a space division multiple access (SDMA) based communication protocol, or the like.

Also, the communication system 100 may further include a core network. When the communication system 100 supports the 4G communication, the core network may comprise a serving gateway (S-GW), a packet data network (PDN) gateway (P-GW), a mobility management entity (MME), and the like. When the communication system 100 supports the 5G communication, the core network may comprise a user plane function (UPF), a session management function (SMF), an access and mobility management function (AMF), and the like.

Meanwhile, each of the plurality of communication nodes 110-1, 110-2, 110-3, 120-1, 120-2, 130-1, 130-2, 130-3, 130-4, 130-5, and 130-6 constituting the communication system 100 may have the following structure.

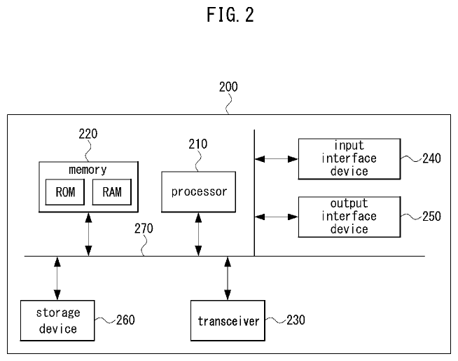

FIG. 2 is a block diagram illustrating an exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may be connected to the processor 210 via an individual interface or a separate bus, rather than the common bus 270. For example, the processor 210 may be connected to at least one of the memory 220, the transceiver 230, the input interface device 240, the output interface device 250, and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. The communication system 100 including the base stations 110-1, 110-2, 110-3, 120-1, and 120-2 and the terminals 130-1, 130-2, 130-3, 130-4, 130-5, and 130-6 may be referred to as an ‘access network’. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B, a evolved Node-B (eNB), a base transceiver station (BTS), a radio base station, a radio transceiver, an access point, an access node, a road side unit (RSU), a radio remote head (RRH), a transmission point (TP), a transmission and reception point (TRP), an eNB, a gNB, or the like.

Here, each of the plurality of terminals 130-1, 130-2, 130-3, 130-4, 130-5, and 130-6 may refer to a user equipment (UE), a terminal, an access terminal, a mobile terminal, a station, a subscriber station, a mobile station, a portable subscriber station, a node, a device, an Internet of things (IoT) device, a mounted apparatus (e.g., a mounted module/device/terminal or an on-board device/terminal, etc.), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

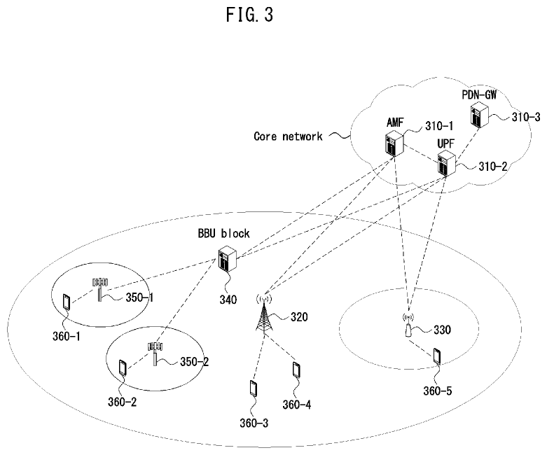

FIG. 3 shows a connection method (example) between a base station and a core network in a wireless communication network using fronthaul and backhaul. In a wireless communication network, a base station 310 (or macro base station) or a small base station 330 is connected to a termination node 340 of the core network through a wired backhaul 380. Here, the termination node of the core network may be a serving gateway (SGW), a user plane function (UPF), a mobility management entity (MME), or an access and mobility function (AMF).

In addition, when a function of the base station is configured as being split in to a baseband processing function block 360 (e.g., baseband unit (BBU) or cloud platform) and a remote radio transmission/reception node 320 (e.g., remote radio head (RRH), transmission & reception point (TRP)), they are connected through a wired fronthaul 370.

The functions of the baseband processing function block 360 may be located in the base station 310 that supports a plurality of remote radio transmit/receive nodes 320 or may be configured as logical functions in the middle of the base station 310 and the SGW/MME (or UPF/AMF) 340 to support a plurality of base stations. In this case, the functions of the baseband processing function block 360 may be physically configured independently of the base station 310 and the SGW/MME 340 or operated as being installed in the base station 310 (or SGW/MME 340).

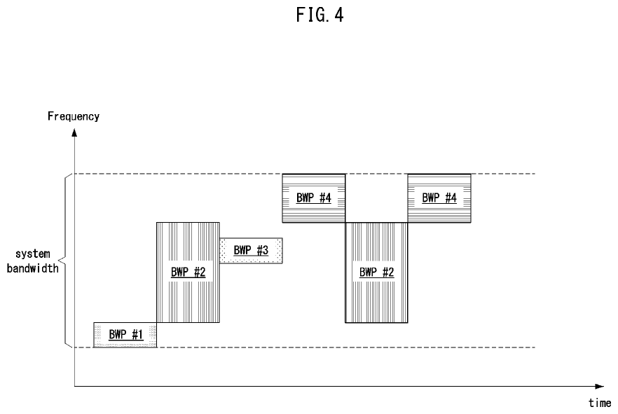

Each of remote radio transmission/reception nodes 320, 420-1, and 420-2 of FIGS. 3 and 4 and base stations 110-1, 110-2, 110-3, and 120-1 shown in FIGS. 1, 3, and 4 may support OFDM, OFDMA, SC-FDMA, or NOMA-based downlink transmission and uplink transmission. In a case where the remote radio transmission/reception nodes of FIGS. 3 and 4 and the plurality of base stations shown in FIGS. 1, 3, and 4 support beamforming functions by using antenna arrays through a transmission carrier of a mmWave band, each may provide services without interference between beams within a base station through a formed beam, and provide services for a plurality of terminals (or UEs) within one beam.

Also, each of the plurality of base stations 110-1, 110-2, 110-3, 120-1, and 120-2 may support multi-input multi-output (MIMO) transmission (e.g., a single-user MIMO (SU-MIMO), multi-user MIMO (MU-MIMO), massive MIMO, or the like), coordinated multipoint (CoMP) transmission, carrier aggregation (CA) transmission, transmission in an unlicensed band, device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2, and operations supported by the plurality of base stations 110-1, 110-2, 110-3, 120-1, and 120-2. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, operation methods for SDT in a communication system will be described. Even when a method (e.g., transmission or reception of a data packet) performed at a first communication node among communication nodes is described, the corresponding second communication node may perform a method (e.g., reception or transmission of the data packet) corresponding to the method performed at the first communication node. That is, when an operation of a terminal is described, the corresponding base station may perform an operation corresponding to the operation of the terminal. Conversely, when an operation of the base station is described, the corresponding terminal may perform an operation corresponding to the operation of the base station.

In the following description, the UPF (or, S-GW) may refer to a termination communication node of the core network that exchanges packets (e.g., control information, data) with the base station, and the AMF (or, MME) may refer to a communication node in the core network, which performs control functions in a radio access section (or, interface) of the terminal. Here, each of the backhaul link, fronthaul link, Xhaul link, DU, CU, BBU block, S-GW, MME, AMF, and UPF may be referred to as a different term according to a function (e.g., function of the Xhaul network, function of the core network) of a communication protocol depending on a radio access technology (RAT).

In order to perform a mobility support function and a radio resource management function, the base station may transmit a synchronization signal (e.g., a synchronization signal/physical broadcast channel (SS/PBCH) block) and/or a reference signal. In order to support multiple numerologies, frame formats supporting symbols having different lengths may be configured. In this case, the terminal may perform a monitoring operation on the synchronization signal and/or reference signal in a frame according to an initial numerology, a default numerology, or a default symbol length. Each of the initial numerology and the default numerology may be applied to a frame format applied to radio resources in which a UE-common search space is configured, a frame format applied to radio resources in which a control resource set (CORESET) #0 of the NR communication system is configured, and/or a frame format applied to radio resources in which a synchronization symbol burst capable of identifying a cell in the NR communication system is transmitted.

The frame format may refer to information of configuration parameters (e.g., values of the configuration parameters, offset, index, identifier, range, periodicity, interval, duration, etc.) for a subcarrier spacing, control channel (e.g., CORESET), symbol, slot, and/or reference signal. The base station may inform the frame format to the terminal using system information and/or a control message (e.g., dedicated control message).

The terminal connected to the base station may transmit a reference signal (e.g., uplink dedicated reference signal) to the base station using resources configured by the corresponding base station. For example, the uplink dedicated reference signal may include a sounding reference signal (SRS). In addition, the terminal connected to the base station may receive a reference signal (e.g., downlink dedicated reference signal) from the base station in resources configured by the corresponding base station. The downlink dedicated reference signal may be a channel state information-reference signal (CSI-RS), a phase tracking-reference signal (PT-RS), a demodulation-reference signal (DM-RS), or the like. Each of the base station and the terminal may perform a beam management operation through monitoring on a configured beam or an active beam based on the reference signal.

For example, the first base station 611 may transmit a synchronization signal and/or a reference signal so that the first terminal 621 located within its service area can search for itself to perform downlink synchronization maintenance, beam configuration, or link monitoring operations. The first terminal 621 connected to the first base station 611 (e.g., serving base station) may receive physical layer radio resource configuration information for connection configuration and radio resource management from the first base station 611. The physical layer radio resource configuration information may mean configuration parameters included in RRC control messages of the LTE communication system or the NR communication system. For example, the resource configuration information may include PhysicalConfigDedicated, PhysicalCellGroupConfig, PDCCH-Config(Common), PDSCH-Config(Common), PDCCH-ConfigSIB1, ConfigCommon, PUCCH-Config(Common), PUSCH-Config(Common), BWP-DownlinkCommon, BWP-UplinkCommon, ControlResourceSet, RACH-ConfigCommon, RACH-ConfigDedicated, RadioResourceConfigCommon, RadioResourceConfigDedicated, ServingCellConfig, ServingCellConfigCommon, and the like.

The radio resource configuration information may include parameter values such as a configuration (or allocation) periodicity of a signal (or radio resource) according to a frame format of the base station (or transmission frequency), time resource allocation information for transmission, frequency resource allocation information for transmission, a transmission (or allocation) time, or the like. In order to support multiple numerologies, the frame format of the base station (or transmission frequency) may mean a frame format having different symbol lengths according to a plurality of subcarrier spacings within one radio frame. For example, the number of symbols constituting each of a mini-slot, slot, and subframe that exist within one radio frame (e.g., a frame of 10 ms) may be configured differently.
Configuration information of transmission frequency and frame format of base station

Transmission frequency configuration information: information on all transmission carriers (i.e., cell-specific transmission frequency) in the base station, information on bandwidth parts (BWPs) in the base station, information on a transmission reference time or time difference between transmission frequencies of the base station (e.g., a transmission periodicity or offset parameter indicating the transmission reference time (or time difference) of the synchronization signal), etc.

Frame format configuration information: configuration parameters of a mini-slot, slot, and subframe having a different symbol length according to a subcarrier spacing
Configuration information of downlink reference signal (e.g., channel state information-reference signal (CSI-RS), common reference signal (Common-RS), etc.)

Configuration parameters such as a transmission periodicity, transmission position, code sequence, or masking (or scrambling) sequence for a reference signal, which are commonly applied within the coverage of the base station (or beam).
Configuration information of uplink control signal

Configuration parameters such as a sounding reference signal (SRS), uplink beam sweeping (or beam monitoring) reference signal, uplink grant-free radio resources (or, preambles), etc.
Configuration information of physical downlink control channel (e.g., PDCCH)

Configuration parameters such as a reference signal for PDCCH demodulation, beam common reference signal (e.g., reference signal that can be received by all terminals within a beam coverage), beam sweeping (or beam monitoring) reference signal, reference signal for channel estimation, etc.
Configuration information of physical uplink control channel (e.g., PUCCH)
Scheduling request signal configuration information
Configuration information for a feedback (acknowledgement (ACK) or negative ACK (NACK)) transmission resource in a hybrid automatic repeat request (HARQ) procedure
Number of antenna ports, antenna array information, beam configuration or beam index mapping information for application of beamforming techniques
Configuration information of downlink signal and/or uplink signals (or uplink access channel resource) for beam sweeping (or beam monitoring)
Configuration information of parameters for beam configuration, beam recovery, beam reconfiguration, or radio link re-establishment operation, beam change operation within the same base station, reception signal of a beam triggering a handover procedure to another base station, timers controlling the above-described operations, etc.

In case of a radio frame format that supports a plurality of symbol lengths for supporting multi-numerology, the configuration (or allocation) periodicity of the parameter, the time resource allocation information, the frequency resource allocation information, the transmission time, and/or the allocation time, which constitute the above-described information, may be information configured for each corresponding symbol length (or subcarrier spacing).

In the following exemplary embodiments, ‘Resource-Config information’ may be a control message including one or more parameters of the physical layer radio resource configuration information. In addition, the ‘Resource-Config information’ may mean attributes and/or configuration values (or range) of information elements (or parameters) delivered by the control message. The information elements (or parameters) delivered by the control message may be radio resource configuration information applied commonly to the entire coverage of the base station (or, beam) or radio resource configuration information allocated dedicatedly to a specific terminal (or, specific terminal group). A terminal group may include one or more terminals.

The configuration information included in the ‘Resource-Config information’ may be transmitted through one control message or different control messages according to the attributes of the configuration information. The beam index information may not express the index of the transmission beam and the index of the reception beam explicitly. For example, the beam index information may be expressed using a reference signal mapped or associated with the corresponding beam index or an index (or identifier) of a transmission configuration indicator (TCI) state for beam management.

Therefore, the terminal operating in the RRC connected state may receive a communication service through a beam (e.g., beam pair) configured between the terminal and the base station. For example, when a communication service is provided using beam configuration (e.g., beam pairing) between the base station and the terminal, the terminal may perform a search operation or a monitoring operation of a radio channel by using a synchronization signal (e.g., SS/PBCH block) and/or a reference signal (e.g., CSI-RS) of a beam configured with the base station, or a beam the can be received. Here, the expression that a communication service is provided through a beam may mean that a packet is transmitted and received through an active beam among one or more configured beams. In the NR communication system, the expression that a beam is activated may mean that a configured TCI state is activated.

The terminal may operate in the RRC idle state or the RRC inactive state. In this case, the terminal may perform a search operation (e.g., monitoring operation) of a downlink channel by using parameter(s) obtained from system information or common Resource-Config information. In addition, the terminal operating in the RRC idle state or the RRC inactive state may attempt to access by using an uplink channel (e.g., a random access channel or a physical layer uplink control channel). Alternatively, the terminal may transmit control information by using an uplink channel.

The terminal may recognize or detect a radio link problem by performing a radio link monitoring (RLM) operation. Here, the expression that a radio link problem is detected may mean that physical layer synchronization configuration or maintenance for a radio link has a problem. For example, the expression that a radio link problem is detected may mean that it is detected that the physical layer synchronization between the base station and the terminal is not maintained during a preconfigured time. When a radio link problem is detected, the terminal may perform a recovery operation of the radio link. When the radio link is not recovered, the terminal may declare a radio link failure (RLF) and perform a re-establishment procedure of the radio link.

The procedure for detecting a physical layer problem of a radio link, procedure for recovering a radio link, procedure for detecting (or declaring) a radio link failure, and procedure for re-establishing a radio link according to the RLM operation may be performed by functions of a layer 1 (e.g., physical layer), a layer 2 (e.g., MAC layer, RLC layer, PDCP layer, etc.), and/or a layer 3 (e.g., RRC layer) of the radio protocol.

The physical layer of the terminal may monitor a radio link by receiving a downlink synchronization signal (e.g., primary synchronization signal (PSS), secondary synchronization signal (SSS), SS/PBCH block) and/or a reference signal. In this case, the reference signal may be a base station common reference signal, beam common reference signal, or terminal (or terminal group) specific reference signal (e.g., dedicated reference signal allocated to a terminal (or terminal group)). Here, the common reference signal may be used for channel estimation operations of all terminals located within the corresponding base station or beam coverage (or service area). The dedicated reference signal may be used for a channel estimation operation of a specific terminal or a specific terminal group located within the base station or beam coverage.

Accordingly, when the base station or the beam (e.g., configured beam between the base station and the terminal) is changed, the dedicated reference signal for beam management may be changed. The beam may be changed based on the configuration parameter(s) between the base station and the terminal. A procedure for changing the configured beam may be required. The expression that a beam is changed in the NR communication system may mean that an index (or identifier) of a TCI state is changed to an index of another TCI state, that a TCI state is newly configured, or that a TCI state is changed to an active state. The base station may transmit system information including configuration information of the common reference signal to the terminal. The terminal may obtain the common reference signal based on the system information. In a handover procedure, synchronization reconfiguration procedure, or connection reconfiguration procedure, the base station may transmit a dedicated control message including the configuration information of the common reference signal to the terminal.

The configured beam information may include at least one of a configured beam index (or identifier), configured TCI state index (or identifier), configuration information of each beam (e.g., transmission power, beam width, vertical angle, horizontal angle), transmission and/or reception timing information of each beam (e.g., subframe index, slot index, mini-slot index, symbol index, offset), reference signal information corresponding to each beam, and reference signal identifier.

In the exemplary embodiments, the base station may be a base station installed in the air. For example, the base station may be installed on an unmanned aerial vehicle (e.g., drone), a manned aircraft, or a satellite.

The terminal may receive configuration information of the base station (e.g., identification information of the base station) from the base station through one or more of an RRC message, MAC message, and PHY message, and may identify a base station with which the terminal performs a beam monitoring operation, radio access operation, and/or control (or data) packet transmission and reception operation.

The result of the measurement operation (e.g., beam monitoring operation) for the beam may be reported through a physical layer control channel (e.g., PUCCH) and/or a MAC message (e.g., MAC CE, control PDU). Here, the result of the beam monitoring operation may be a measurement result for one or more beams (or beam groups). For example, the result of the beam monitoring operation may be a measurement result for beams (or beam groups) according to a beam sweeping operation of the base station.

The base station may obtain the result of the beam measurement operation or the beam monitoring operation from the terminal, and may change the properties of the beam or the properties of the TCI state based on the result of the beam measurement operation or the beam monitoring operation. The beam may be classified into a primary beam, a secondary beam, a reserved (or candidate) beam, an active beam, and a deactivated beam according to its properties. The TCI state may be classified into a primary TCI state, a secondary TCI state, a reserved (or candidate) TCI state, a serving TCI state, a configured TCI state, an active TCI state, and a deactivated TCI state according to its properties. Each of the primary TCI state and the secondary TCI state may be assumed to be an active TCI state and a serving TCI state. The reserved (or candidate) TCI state may be assumed to be a deactivated TCI state or a configured TCI state.

Each of the primary TCI state and the secondary TCI state may be assumed to be an active TCI state or a serving TCI state capable of transmitting or receiving data packets or control signaling even with restriction. In addition, the reserved (or candidate) TCI state may be assumed to be a deactivate TCI state or a configured TCI state in which data packets or control signaling cannot be transmitted or received while being a measurement or management target.

A procedure for changing the beam (or TCI state) property may be controlled by the RRC layer and/or the MAC layer. When the procedure for changing the beam (or TCI state) property is controlled by the MAC layer, the MAC layer may inform the higher layer of information regarding a change in the beam (or TCI state) property. The information regarding the change in the beam (or TCI state) property may be transmitted to the terminal through a MAC message and/or a physical layer control channel (e.g., PDCCH). The information regarding the change in the beam (or TCI state) property may be included in downlink control information (DCI) or uplink control information (UCI). The information regarding the change in the beam (or TCI state) property may be expressed as a separate indicator or field.

The terminal may request to change the property of the TCI state based on the result of the beam measurement operation or the beam monitoring operation. The terminal may transmit control information (or feedback information) requesting to change the property of the TCI state to the base station by using one or more of a PHY message, a MAC message, and an RRC message. The control information (or feedback information, control message, control channel) requesting to change the property of the TCI state may be configured using one or more of the configured beam information described above.

The change in the property of the beam (or TCI state) may mean a change from the active beam to the deactivated beam, a change from the deactivated beam to the active beam, a change from the primary beam to the secondary beam, a change from the secondary beam to the primary beam, a change from the primary beam to the reserved (or candidate) beam, or a change from the reserved (or candidate) beam to the primary beam. The procedure for changing the property of the beam (or TCI state) may be controlled by the RRC layer and/or the MAC layer. The procedure for changing the property of the beam (or TCI state) may be performed through partial cooperation between the RRC layer and the MAC layer.

When a plurality of beams are allocated, one or more beams among the plurality of beams may be configured as beam(s) for transmitting physical layer control channels. For example, the primary beam and/or the secondary beam may be used for transmission and reception of a physical layer control channel (e.g., PHY message). Here, the physical layer control channel may be a PDCCH or a PUCCH. The physical layer control channel may be used for transmission of one or more among scheduling information (e.g., radio resource allocation information, modulation and coding scheme (MCS) information), feedback information (e.g., channel quality indication (CQI), precoding matrix indicator (PMI), HARQ ACK, HARQ NACK), resource request information (e.g., scheduling request (SR)), result of the beam monitoring operation for supporting beamforming functions, TCI state ID, and measurement information for the active beam (or deactivated beam).

The physical layer control channel may be configured to be transmitted through the primary beam of downlink. In this case, the feedback information may be transmitted and received through the primary beam, and data scheduled by the control information may be transmitted and received through the secondary beam. The physical layer control channel may be configured to be transmitted through the primary beam of uplink. In this case, the resource request information (e.g., SR) and/or the feedback information may be transmitted and received through the primary beam.

In the procedure of allocating the plurality of beams (or the procedure of configuring the TCI states), the allocated (or configured) beam indices, information indicating a spacing between the beams, and/or information indicating whether contiguous beams are allocated may be transmitted and received through a signaling procedure between the base station and the terminal. The signaling procedure of the beam allocation information may be performed differently according to status information (e.g., movement speed, movement direction, location information) of the terminal and/or the quality of the radio channel. The base station may obtain the status information of the terminal from the terminal. Alternatively, the base station may obtain the status information of the terminal through another method.

The radio resource information may include parameter(s) indicating frequency domain resources (e.g., center frequency, system bandwidth, PRB index, number of PRBs, CRB index, number of CRBs, subcarrier index, frequency offset, etc.) and parameter(s) indicating time domain resources (e.g., radio frame index, subframe index, transmission time interval (TTI), slot index, mini-slot index, symbol index, time offset, and periodicity, length, or window of transmission period (or reception period)). In addition, the radio resource information may further include a hopping pattern of radio resources, information for beamforming (e.g., beam shaping) operations (e.g., beam configuration information, beam index), and information on resources occupied according to characteristics of a code sequence (or bit sequence, signal sequence).

The name of the physical layer channel and/or the name of the transport channel may vary according to the type (or attribute) of data, the type (or attribute) of control information, a transmission direction (e.g., uplink, downlink, sidelink), and the like.

The reference signal for beam (or TCI state) or radio link management may be a synchronization signal (e.g., PSS, SSS, SS/PBCH block), CSI-RS, PT-RS, SRS, DM-RS, or the like. The reference parameter(s) for reception quality of the reference signal for beam (or TCI state) or radio link management may include a measurement time unit, a measurement time interval, a reference value indicating an improvement in reception quality, a reference value indicating a deterioration in reception quality, or the like. Each of the measurement time unit and the measurement time interval may be configured in units of an absolute time (e.g., millisecond, second), TTI, symbol, slot, frame, subframe, scheduling periodicity, operation periodicity of the base station, or operation periodicity of the terminal.

The reference value indicating the change in reception quality may be configured as an absolute value (dBm) or a relative value (dB). In addition, the reception quality of the reference signal for beam (or TCI state) or radio link management may be expressed as a reference signal received power (RSRP), a reference signal received quality (RSRQ), a received signal strength indicator (RSSI), a signal-to-noise ratio (SNR), a signal-to-interference ratio (SIR), or the like.

Meanwhile, in the NR communication system using a millimeter frequency band, flexibility for a channel bandwidth operation for packet transmission may be secured based on a bandwidth part (BWP) concept. The base station may configure up to 4 BWPs having different bandwidths to the terminal. The BWPs may be independently configured for downlink and uplink. That is, downlink BWPs may be distinguished from uplink BWPs. Each of the BWPs may have a different subcarrier spacing as well as a different bandwidth. For example, BWPs may be configured as follows.

FIG. 4 is a conceptual diagram illustrating an exemplary embodiment of a method of configuring bandwidth parts (BWPs) in a communication system.

As shown in FIG. 4, a plurality of bandwidth parts (e.g., BWPs #1 to #4) may be configured within a system bandwidth of the base station. The BWPs #1 to #4 may be configured not to be larger than the system bandwidth of the base station. The bandwidths of the BWPs #1 to #4 may be different, and different subcarrier spacings may be applied to the BWPs #1 to #4. For example, the bandwidth of the BWP #1 may be 10 MHz, and the BWP #1 may have a 15 kHz subcarrier spacing. The bandwidth of the BWP #2 may be 40 MHz, and the BWP #2 may have a 15 kHz subcarrier spacing. The bandwidth of the BWP #3 may be 10 MHz, and the BWP #3 may have a 30 kHz subcarrier spacing. The bandwidth of the BWP #4 may be 20 MHz, and the BWP #4 may have a 60 kHz subcarrier spacing.

The BWPs may be classified into an initial BWP (e.g., first BWP), an active BWP (e.g., activated BWP), and a default BWP. The terminal may perform an initial access procedure (e.g., access procedure) with the base station in the initial BWP. One or more BWPs may be configured through an RRC connection configuration message, and one BWP among the one or more BWPs may be configured as the active BWP. Each of the terminal and the base station may transmit and receive packets in the active BWP among the configured BWPs. Therefore, the terminal may perform a monitoring operation on control channels for packet transmission and reception in the active BWP.

The terminal may switch the operating BWP from the initial BWP to the active BWP or the default BWP. Alternatively, the terminal may switch the operating BWP from the active BWP to the initial BWP or the default BWP. The BWP switching operation may be performed based on an indication of the base station or a timer. The base station may transmit information indicating the BWP switching to the terminal using one or more of an RRC message, a MAC message (e.g., MAC control element (CE)), and a PHY message (e.g., DCI). The terminal may receive the information indicating the BWP switching from the base station, and may switch the operating BWP of the terminal to a BWP indicated by the received information.

When a random access (RA) resource is not configured in the active uplink (UL) BWP in the NR communication system, the terminal may switch the operating BWP of the terminal from the active UL BWP to the initial UL BWP in order to perform a random access procedure. The operating BWP may be a BWP in which the terminal performs communication (e.g., transmission and reception operation of a signal and/or channel).

Measurement operations (e.g., monitoring operations) for beam (or TCI state) or radio link management may be performed at the base station and/or the terminal. The base station and/or the terminal may perform the measurement operations (e.g., monitoring operations) according to parameter(s) configured for the measurement operations (e.g., monitoring operations). The terminal may report a measurement result according to parameter(s) configured for measurement reporting.

When a reception quality of a reference signal according to the measurement result meets a preconfigured reference value and/or a preconfigured timer condition, the base station may determine whether to perform a beam (or, radio link) management operation, a beam switching operation, or a beam deactivation (or, activation) operation according to a beam blockage situation. When it is determined to perform a specific operation, the base station may transmit a message triggering execution of the specific operation to the terminal. For example, the base station may transmit a control message for instructing the terminal to execute the specific operation to the terminal. The control message may include configuration information of the specific operation.

When a reception quality of a reference signal according to the measurement result meets a preconfigured reference value and/or a preconfigured timer condition, the terminal may report the measurement result to the base station. Alternatively, the terminal may transmit to the base station a control message triggering a beam (or, radio link) management operation, a beam switching operation (or a TCI state ID change operation, a property change operation), or a beam deactivation operation (or a beam activation operation) according to a beam blockage situation. The control message may request to perform a specific operation.

A basic procedure for beam (or TCI state) management through the radio link monitoring may include a beam failure detection (BFD) procedure, a beam recovery (BR) request procedure, and the like for a radio link. An operation of determining whether to perform the beam failure detection procedure and/or the beam recovery request procedure, an operation triggering execution of the beam failure detection procedure and/or the beam recovery request procedure, and a control signaling operation for the beam failure detection procedure and/or the beam recovery request procedure may be performed by one or more of the PHY layer, the MAC layer, and the RRC layer.

The procedure for the terminal to access the base station (e.g., random access procedure) may be classified into an initial access procedure and a non-initial access procedure. The terminal operating in the RRC idle state may perform the initial access procedure. Alternatively, when there is no context information managed by the base station, the terminal operating in the RRC connected state may also perform the initial access procedure. The context information may include RRC context information, access stratum (AS) configuration information (e.g., AS context information), and the like. The context information may include one or more among RRC configuration information for the terminal, security configuration information for the terminal, PDCP information including a robust header compression (ROHC) state for the terminal, an identifier (e.g., cell-radio resource temporary identifier (C-RNTI)) for the terminal, and an identifier of the base station for which a connection configuration with the terminal has been completed.

The non-initial access procedure may refer to an access procedure performed by the terminal in addition to the initial access procedure. For example, the non-initial access procedure may be performed for an access request for transmission or reception data arrival at the terminal, connection resumption, resource allocation request, user (UE) request based information transmission request, link re-establishment request after a radio link failure (RLF), mobility function (e.g., handover function) support, secondary cell addition/change, active beam addition/change, or physical layer synchronization configuration.

The random access procedure may be performed based on the initial access procedure or the non-initial access procedure according to the operation state of the terminal.

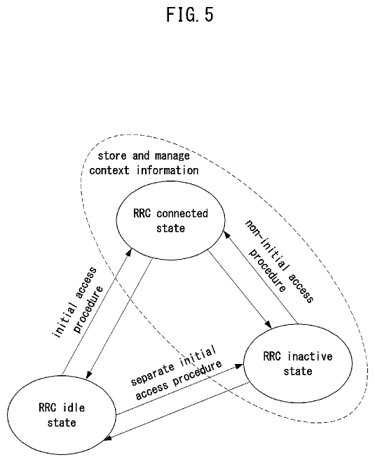

FIG. 5 is a conceptual diagram illustrating an exemplary embodiment of operation states of a terminal in a communication system.

As shown in FIG. 5, operation states of the terminal may be classified into an RRC connected state, an RRC inactive state, and an RRC idle state. When the terminal operates in the RRC connected state or the RRC inactive state, a radio access network (RAN) (e.g., a control function block of the RAN) and the base station may store and manage RRC connection configuration information and/or context information (e.g., RRC context information, AS context information) of the corresponding terminal.

The terminal operating in the RRC connected state may receive configuration information of physical layer control channels and/or reference signals required for maintaining connection configuration and transmission/reception of data from the base station. The reference signal may be a reference signal for demodulating the data. Alternatively, the reference signal may be a reference signal for channel quality measurement or beamforming. Therefore, the terminal operating in the RRC connected state may transmit and receive the data without delay.

When the terminal operates in the RRC inactive state, mobility management functions/operations identical or similar to mobility management functions/operations supported in the RRC idle state may be supported for the corresponding terminal. That is, when the terminal operates in the RRC inactive state, a data bearer for transmitting and receiving data may not be configured, and functions of the MAC layer may be deactivated. Accordingly, the terminal operating in the RRC inactive state may transition the operation state of the terminal from the RRC inactive state to the RRC connected state by performing the non-initial access procedure to transmit data. Alternatively, the terminal operating in the RRC inactive state may transmit data having a limited size, data having a limited quality of service, and/or data associated with a limited service.

When the terminal operates in the RRC idle state, there may be no connection configuration between the terminal and the base station, and the RRC connection configuration information and/or context information (e.g., RRC context information, AS context information) of the terminal may not be stored in the RAN (e.g., a control function block of the RAN) and the base station. In order to transition the operation state of the terminal from the RRC idle state to the RRC connected state, the terminal may perform the initial access procedure. Alternatively, when the initial access procedure is performed, the operation state of the terminal may transition from the RRC idle state to the RRC inactive state according to determination of the base station.

The terminal may transition from the RRC idle state to the RRC inactive state by performing the initial access procedure or a separate access procedure defined for the RRC inactive state. When a limited service is provided to the terminal, the operation state of the terminal may transition from the RRC idle state to the RRC inactive state. Alternatively, depending on capability of the terminal, the operation state of the terminal may transition from the RRC idle state to the RRC inactive state.

The base station and/or the control function block of the RAN may configure condition(s) for transitioning to the RRC inactive sate by considering one or more of the type, capability, and service (e.g., a service currently being provided and a service to be provided) of the terminal, and may control the operation for transitioning to the RRC inactive state based on the configured condition(s). When the base station allows the transition to the RRC inactive state or when the transition to the RRC inactive state is configured to be allowed, the operation state of the terminal may be transitioned from the RRC connected state or the RRC idle state to the RRC inactive state.

Configuration and Conditions for Small Data Transmission (SDT)

Data having a small size and/or a signaling message having a small size (hereinafter referred to as ‘small data transmission (SDT)’) may occur intermittently. Here, the ‘small data transmission (SDT)’ may refer to a transmission operation of small data, or may refer to the small data itself. For example, an expression ‘transmission of SDT’ or ‘SDT is transmitted’ may mean a transmission operation of small data or that the small data is transmitted, and a term ‘SDT packet’ may mean a small data packet or a packet belonging to the SDT. That is, the SDT may refer to data or signaling information that is intermittently occurring with a size less than or equal to a predetermined size. When an SDT occurs in the base station, the base station may perform the SDT to the terminal operating in the RRC idle state or the RRC inactive state. When an SDT occurs in the terminal, the terminal (e.g., the terminal operating in the RRC idle state or the RRC inactive state) may perform the SDT to the base station. Here, the SDT may be performed through a paging procedure or a random access procedure.

The base station may transmit configuration information related to SDT to the terminal. An uplink SDT occurring in the terminal may be performed by using a random access (RA) procedure or by using a configured grant (CG) resource preconfigured (or allocated) for SDT. That is, the base station may configure CG resources for SDT and deliver configuration information of the CG resources to the terminal so that the terminal performs an intermittently occurring SDT.

In addition, the base station may deliver configuration information indicating whether SDT using an RA procedure and/or a CG resource is allowed to the terminal as system information or a separate control message. Here, the separate control message may be a control message for configuring an RRC connection, a control message for releasing an RRC connection, or an RRC state transition control message (e.g., a control message for transition to the inactive state).

In a method of performing an uplink SDT, an RA procedure or a CG resource may be used according to a connection state of the terminal and/or whether uplink physical layer synchronization (hereinafter, referred to as uplink synchronization) of the terminal is maintained. For example, a terminal maintaining uplink synchronization or a terminal in the connected state may perform the SDT by using a CG resource. On the other hand, a terminal in the inactive state or idle state, a terminal not maintaining uplink synchronization, a terminal in which a CG resource is not configured, or a terminal in which a configured CG resource is not valid may perform the SDT by using an RA procedure. That is, a terminal in the inactive state or in the idle state in which a CG resource is configured may perform the SDT by using the CG resource. If a CG resource condition for SDT is not satisfied, the terminal may perform the SDT by using an RA procedure.

In addition, in case of a CG resource configured so that a terminal not maintaining uplink synchronization can use it for SDT, a terminal in the inactive or idle state or a terminal not maintaining uplink synchronization may also use the CG resource to perform the SDT.

In addition, when uplink synchronization does not need to be maintained in a service coverage of the base station or transmission timing adjustment information of the terminal for maintaining uplink synchronization is not required, the base station may use system information or a separate control message to deliver one or more of the following information to the terminal. Here, the separate control message may be a control message for configuring an RRC connection, a control message for releasing an RRC connection, or an RRC state transition control message (e.g., a transition control message to the inactive state).
Information notifying that there is no need for an operation (or procedure) for maintaining uplink synchronization (or information indicating that uplink synchronization is valid)
Information notifying that SDT using a CG resource is allowed even when uplink synchronization is not maintained
Information notifying that a timer (e.g., timeAlignmentTimer) value for an operation for maintaining uplink synchronization is set to infinity

When one or more of the above information is delivered from the base station to the terminal, the terminal in the inactive state or idle state may perform SDT by using a CG resource even when uplink synchronization is not maintained.

The information notifying that an operation (or procedure) for maintaining uplink synchronization is not required or that uplink synchronization (or timing advance (TA) synchronization) is valid may be configured based on the size of the base station service coverage, an uplink synchronization maintenance timer of the terminal (or a separate timer for determining whether SDT using a CG resource is allowed), a channel quality of a radio link, or position information of the terminal. For example, when compensation for a path delay is not required or uplink synchronization (or TA synchronization) is always valid according to the size of the base station service coverage, SDT using a CG resource may be allowed. For example, the uplink synchronization maintenance timer of the terminal is a separate timer for determining whether SDT using a CG resource is allowed, and when the uplink synchronization maintenance timer satisfies a reference condition (or value), SDT using a CG resource may be allowed. For example, if a distance between the terminal and the base station is determined to be a distance that does not require compensation for a path delay based on the position information of the terminal, SDT using a CG resource may be allowed regardless of whether or not TA is maintained or based on that the TA synchronization (or uplink synchronization) is valid. Here, the position information of the terminal may refer to a geographical position of the terminal or a relative position within the base station, which is estimated (or measured) by the terminal based on a position estimation algorithm, a GPS function, or a built-in sensor.

In addition, when a channel quality of a radio link between the serving or camped base station and the terminal satisfies a predefined reference condition (or value), it may be determined that a distance between the terminal and the base station is a distance that does not require compensation for a path delay or a distance that TA synchronization (or uplink synchronization) is valid. Therefore, in this case, SDT using a CG resource may be allowed. Here, the reference condition for the channel quality of the radio link may be a case in which one or more of the following parameters are satisfied.
When a channel quality of a radio link is higher than a reference value
When a channel quality remains above a reference value until a predetermined timer expires or for a predetermined time window
When a change or variation range of a channel quality of a radio link is equal to or higher than a reference value
When a change or variation range of a channel quality satisfies a reference condition until a predetermined timer expires or for a predetermined time window

Therefore, based on the size of the base station service coverage, the uplink synchronization maintenance timer of the terminal, the channel quality of the radio link, or the position information of the terminal, the base station may deliver to the terminal information indicating whether SDT using a CG resource is allowed regardless of whether uplink synchronization is maintained (or, TA is maintained) and/or information of a reference value (or threshold value) for determining whether SDT using a CG resource is possible through system information or an RRC control message.

The terminal may obtain the information indicating whether SDT using a CG resource is allowed and/or the information on a reference value (or threshold) for determining whether SDT using a CG resource is possible. Even when the terminal obtaining the above information is a terminal in the inactive state or idle state, or a terminal not maintaining uplink synchronization, the corresponding terminal may perform SDT by using a CG resource when the reference condition is satisfied according to the obtained information.

In addition, when the terminal receives a message indicating transition from the RRC connected state to the RRC inactive state, a last reception time of uplink transmission timing adjustment information (TA information), a last reception time from the base station, or when a predetermined uplink synchronization maintenance timer (or a separate timer for determining whether SDT using a CG resource is allowed) from a last transmission time of the terminal does not expire, the terminal may determine that compensation for a path delay with the base station is not required or that TA synchronization (or UL synchronization) is valid, and may perform SDT by using a CG resource.

In addition, the terminal may be controlled to perform SDT by using a CG resource when satisfying one or more conditions or conditions selectively combined from among the size of the base station service coverage, the uplink synchronization maintenance timer of the terminal (or a separate timer for determining whether SDT using a CG resource is allowed), validity of a configured CG resource, the channel quality of radio link, the size of the SDT, and/or the position information of the terminal.

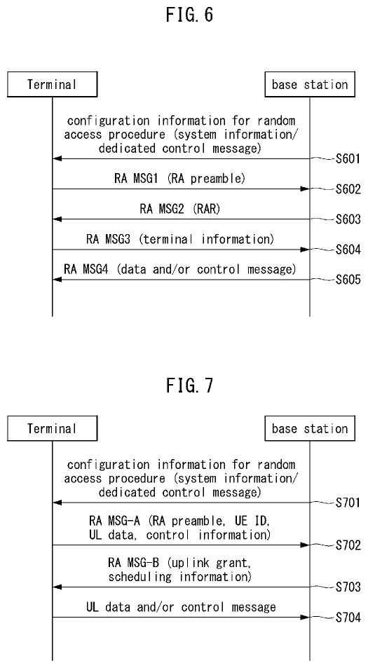

When a CG resource configured for the terminal in the inactive state or idle state described above does not meet the CG resource condition for SDT or is not valid, the terminal may perform SDT by using an RA procedure described below. The RA procedure for SDT may be performed as a radio access (or RA) procedure of a terminal consisting of four steps (4-step) or a radio access (or RA) procedure of a terminal consisting of two steps (2-step). Hereinafter, FIG. 6 is for describing an RA procedure composed of four steps (4-step), and FIG. 7 is for describing an RA procedure composed of two steps (2-step).

Uplink SDT Method Using 4-Step RA Procedure

FIG. 6 is a sequence chart illustrating an uplink SDT method based on a 4-step random access procedure according to an exemplary embodiment of the present disclosure.

Referring to FIG. 6, a communication system may include a base station, a terminal, and the like. The base station may be the base station 110-1, 110-2, 110-3, 120-1, or 120-2 shown in FIG. 1, and the terminal may be the terminal 130-1, 130-2, 130-3, 130-4, 130-5, or 130-6 shown in FIG. 1. The base station and the terminal may be configured to be the same or similar to the communication node shown in FIG. 2. A random access procedure may be performed in four steps.

The base station may transmit system information and/or a control message including configuration information of a radio resource (e.g., uplink radio resource) for the random access procedure to the terminal (S601). The terminal may obtain the configuration information of the radio resource for the random access procedure by receiving the system information and/or control message from the base station. The system information may be common system information used for a plurality of base stations or base station-specific system information (e.g., cell-specific system information). The control message may be a dedicated control message. The control message may be a dedicated control message. Here, the dedicated control message may be a control message for configuring an RRC connection, a control message for releasing an RRC connection, or an RRC state transition control message (e.g., a control message for transition to the inactive state).

The system information may be system information commonly applied to a plurality of base stations or system information for each base station. The system information may be configured for each base station, for each beam group, or for each beam. The system information may include allocation information of the radio resource (e.g., uplink radio resource) for the random access procedure. The configuration information of the radio resource for the random access procedure may include one or more of transmission frequency information of the physical layer, system bandwidth information (or BWP configuration information), subcarrier spacing information, beam configuration information according to a beamforming technique (e.g., beam width, beam index), variable radio resource configuration information (e.g., radio resource reference value, offset) in the frequency and/or time domain, and inactive (or unused) radio resource region/interval information.

The terminal may transmit an RA message 1 (i.e., RA MSG1) including an RA preamble to the base station using the radio resource (e.g., physical random access channel (PRACH)) configured by the base station (S602). The message 1 including the RA preamble may be referred to as an ‘RA MSG1’ in the 4-step random access procedure, the RA preamble in the 4-step random access procedure may be referred to as a ‘4-step-RA preamble’.

The terminal may randomly select a code sequence (e.g., RA preamble, signature) defined for the random access procedure, and transmit the RA MSG1 including the selected code sequence. In a contention-based random access (CBRA) procedure, the terminal may randomly select the RA preamble. In a contention-free random access (CFRA) procedure, the base station may pre-allocate the RA preamble to the terminal. The pre-allocation of the RA preamble may mean that an index, masking information, etc. of the RA preamble for the RA MSG1 is allocated dedicatedly to the terminal. In this case, the terminal may perform the random access procedure (e.g., CFRA procedure) without contention with other terminals.

The base station may receive the RA MSG1 from the terminal, and may generate and transmit a response message for the RA MSG1 (S603). That is, in the step S603, the base station may generate or configure a response message for a random access request (or access attempt) and transmit it to the terminal. Hereinafter, the response message transmitted by the base station (or cell) in the step S603 is referred to as an RA MSG2. The response message transmitted by the base station in the step S603 may be transmitted in form of only a PDCCH (e.g., form of downlink control information (DCI)) for allocating an uplink radio resource, in form of only a PDCCH for the RA response, or through a physical downlink shared channel (PDSCH).

In the case that a PDCCH allocating an uplink radio resource is transmitted in the step S603, the corresponding DCI may include one or more among uplink resource allocation information (e.g., scheduling information), transmission timing adjustment information (e.g., a timing advance (TA) value, a TA command), transmission power adjustment information, backoff information, beam configuration information, TCI state information, configured scheduling (CS) state information, state transition information, PUCCH configuration information, an index of the RA MSG1 received in the step S602 (e.g., an index of the RA preamble), and uplink resource allocation information for transmission of an RA MSG3 in a step S604. Here, the beam configuration information may be information indicating activation or deactivation of a specific beam. The TCI state information may be information indicating activation or deactivation of a specific TCI state. The CS state information may be information indicating activation or deactivation of radio resources allocated in the CS scheme. The state transition information may be information indicating transition of the operation state of the terminal shown in FIG. 5. The state transition information may indicate transition from a specific operation state to the RRC idle state, the RRC connected state, or the RRC inactive state. Alternatively, the state transition information may indicate maintaining of the current operation state. The PUCCH configuration information may be allocation information of a scheduling request (SR) resource. Alternatively, the PUCCH configuration information may be information indicating activation or deactivation of an SR resource.

The base station may transmit only a PDCCH for the RA response in the step S603. In this case, control information may be transmitted through a PDSCH. That is, the control information may include one or more among uplink resource allocation information (e.g., scheduling information), transmission timing adjustment information (e.g., TA value, TA command), transmission power adjustment information, backoff information, beam configuration information, TCI state information, CS state information, state transition information, PUCCH configuration information, the index of the message 1 (e.g., RA preamble) received in the step S602, and uplink resource allocation for transmission of an RA MSG3 in the step S604.

The base station may transmit scheduling information of the RA MSG2 to the terminal using a random access (RA)-RNTI. For example, a cyclic redundancy check (CRC) of the DCI including the scheduling information of the RA MSG2 may be scrambled by the RA-RNTI, and the corresponding DCI may be transmitted through the PDCCH. In addition, the base station may transmit the RA MSG2 using a cell-RNTI (C-RNTI). The base station may transmit the RA MSG2 on a PDSCH indicated by the scheduling information addressed by the scheduling identifier (e.g., RA-RNTI, C-RNTI).

The terminal may receive the RA MSG2 from the base station. The terminal may transmit an RA MSG3 (i.e., message 3) including its own information to the base station (S604). The terminal information may include one or more among the identifier of the terminal, capability, property, mobility status, location information, a reason for the radio access, size information of uplink data to be transmitted (e.g., buffer status report (BSR)), connection configuration request information, and uplink data. In addition, in the step S604, the terminal may transmit information requesting information required by the terminal to the base station.

When the RA MSG2 is received based on the DCI in the step S603, the terminal may perform an operation according to the information element(s) included in the PDCCH (or DCI). The information element(s) included in the PDCCH (or DCI) may include one or more among transition request information of the operation state of the terminal, request information for maintaining the operation state of the terminal, information indicating activation or deactivation of a beam, information indicating activation or deactivation of a TCI state, information indicating activation or deactivation of a CS state. In this case, the random access procedure may be terminated without performing the step S604.

If the RA MSG2 is received based on the DCI, and an uplink radio resource for the RA MSG3 is not allocated in the step S603, the terminal may wait until allocation information of the uplink radio resource for the RA MSG3 is received. When the allocation information of the uplink radio resource for the RA MSG3 is received before a preconfigured timer expires, the terminal may transmit the RA MSG3 to the base station using the uplink radio resource. On the other hand, when the allocation information of the uplink radio resource for the RA MSG3 is not received until the preconfigured timer expires, the terminal may perform the random access procedure again. That is, the terminal may perform again from the step S602.

In a step S605, the base station may transmit downlink information requested by the terminal. Alternatively, the base station may transmit downlink data or a control message to the terminal. In the step S605, the base station may transmit the terminal identifier received from the terminal (e.g., the terminal identifier received in the step S604) to the terminal. A message 4 transmitted by the base station in the step S605 may be referred to as an ‘RA MSG4’.

The base station may transmit resource allocation information (e.g., scheduling information) for transmission of the RA MSG3 to the terminal using the RA MSG2. The scheduling information may include one or more among the identifier of the base station transmitting the scheduling information, beam index, identifier for identifying the scheduling information, radio resource allocation information, MCS information, and resource allocation information for transmission of feedback information (e.g., ACK or NACK) indicating whether the scheduling information is received. The radio resource allocation information may include frequency domain resource allocation information (e.g., transmission band information, subcarrier allocation information) and/or time domain resource allocation information (e.g., frame index, subframe index, slot index, symbol index, transmission period, transmission timing).

In the random access procedure shown in FIG. 6, the RA MSG3 may include one or more of the following information elements.
Capability of the terminal
Properties of the terminal
Mobility state of the terminal
Location information of the terminal
Reason for attempting the access procedure (e.g., random access procedure)

The reason for attempting the access procedure may be a transmission request of system information according to a request of the terminal, transmission request of downlink data according to update of a firmware or essential software of the terminal, or uplink resource allocation request. The information indicating the reason for attempting the access procedure may be information capable of distinguishing the reason for performing the access procedure. The information capable of distinguishing the reason for performing the access procedure may be as follows.
Uplink resource allocation information
Handover request information or measurement result information
Terminal operation state transition (or, change) request information
Resumption information of a radio channel
Re-establishment information of a radio channel
Information related to beam sweeping, beam reconfiguration, or beam change for beam forming
Information related to physical channel synchronization acquisition
Update information of location information
Mobility state or buffer status report

Using the 4-step RA procedure of FIG. 6, the terminal in the idle state or in the inactive state may transmit a data packet or signaling message of an intermittently-occurring SDT (e.g., a control message of the MAC layer or the RRC layer) (e.g., SDT).

The terminal (e.g., the terminal operating in the RRC idle state or the RRC inactive state) may transmit the data packet and/or signaling message of the SDT by using the 4-step random access procedure shown in FIG. 6. The signaling message of the SDT may be a MAC signaling message (e.g., a control message of the MAC layer) or an RRC signaling message (e.g., a control message of the RRC layer).

For SDT, the terminal may transmit at least one of the following information to the base station by using the RA MSG3 and/or a control message (e.g., MAC CE or RRC message) first transmitted after the RA MSG3.
Identifier (ID) of the terminal
Information informing an uplink SDT or a request of SDT
Information indicating the size of the uplink data (e.g., length indicator (LI)). The information indicating the size of the uplink data may indicate the size of the MAC PDU or RRC message or the number of the MAC PDUs and RRC messages.
Information indicating an uplink signaling message (e.g., uplink bearer message) and/or the size of the uplink signaling message (e.g., LI). The information indicating the size of the uplink signaling message may indicate the size of the MAC PDU or RRC message or the number of the MAC PDUs or RRC messages.
Indicator information indicating a range of the size of the uplink data and/or the size of the uplink signaling message
Logical channel identifier (e.g., LCID) of an uplink data bearer or an uplink signaling bearer
Uplink buffer size information (e.g., BSR)
Information indicating whether the size of the SDT (e.g., the size of SDT packet) meets a preconfigured condition
Control message for connection configuration request
Information requesting uplink resource allocation
Measurement result of a radio channel
Information on a desired terminal state after completion of the SDT

The information indicating whether the size of the uplink SDT satisfies a preconfigured condition may be information indicating whether the size of the SDT to be performed by the terminal is less than or equal to a preconfigured condition (or threshold). The base station may determine a size and/or MCS level of an uplink resource allocated to the terminal based on the information indicating whether the size of the uplink SDT satisfies a preconfigured condition. In addition, the reference condition (or threshold) may be information indicating whether one-time transmission of the SDT (i.e., one-shot transmission) is allowed, and/or a reference condition (or threshold) parameter for the size of the SDT (or the number of messages) allowed to be performed as segmented transmission. Here, the segmented transmission refers to a case in which one or more SDTs are performed by being segmented at different transmission times, or uplink radio resources configured or scheduled for the SDT are configured to be temporally different. Here, the reference condition (or threshold) may be preconfigured in the communication system according to a class of the terminal, capability of the terminal, type of the bearer, and/or type (e.g., coverage) of the base station. Alternatively, the reference condition (or threshold) may be a configuration or indication parameter according to the class of the terminal, capability of the terminal, type of the bearer, and/or type (e.g., coverage) of the base station. The base station may deliver the reference condition (or threshold) to the terminal by using system information, an RRC message, a MAC message (e.g., MAC CE), and/or a PHY message (e.g., DCI).

For an uplink SDT, when the terminal delivers the above-described information indicating the size of the uplink data and/or signaling message (e.g., the size of the MAC PDU or RRC message or the number of the MAC PDUs or RRC messages, etc.) and/or information indicating a range of the size of the uplink data and/or uplink signaling message, information indicating whether the SDT is performed as segmented (or information indicating whether the SDT is performed as one-time transmission) may be delivered together by using the RA MSG3 or a control message (e.g., MAC CE or RRC message) transmitted after the RA MSG3. Depending on whether the SDT is performed as segmented, the terminal may transmit a separate control message (e.g., MAC layer and/or RRC layer control message) in addition to the SDT. For example, when the SDT is performed as segmented (e.g., when two or more SDTs are performed through different time and/or frequency uplink radio resources), the terminal may deliver one or more among uplink radio resource request information for performing the segmented SDTs and/or the size of the uplink SDT (e.g., the size of the MAC PDU or RRC message, etc.), the number of messages for the uplink SDT (e.g., the number of the MAC PDUs or RRC messages, etc.), uplink buffer size information (e.g., BSR), a control message for connection configuration request, indication information indicating whether the size of the uplink SDT satisfies a preconfigured condition, information such as a radio channel measurement result, or a desired operation state of the terminal after completion of the SDT. When the control information is transmitted as a MAC layer message, whether the corresponding control information exists and/or value(s) (or configuration parameter range(s)) of the control information may be delivered in form of a MAC (sub)header or a MAC (sub)PDU. For this, a separate logical channel identifier (LCID) may be configured.

When it is determined (or confirmed) that segmented transmission is applied based on the control information received from the terminal, the base station may allocate uplink radio resources and/or CG resources for the segmented transmission of the SDT to the terminal. In this case, frequency-domain configuration information of uplink radio resources and/or CG resources for the SDT and time-domain configuration information such as a transmission start time and/or transmission end time, an SDT period (or window, timer, counter), or a transmission periodicity within the transmission period may be delivered to the terminal. Here, the SDT period (or window, timer, counter) may be a period in which radio link management for SDT and resource allocation (or scheduling) for SDT are valid for the corresponding terminal (or group), or a timer for determining whether the SDT has been successfully performed. The time-domain configuration information may be configured in units of radio frames, subframes, slots, mini-slots, or symbols.

By using the uplink radio resource(s) for SDT allocated from the base station, the terminal may perform the SDT by segmenting it or as one-time transmission. After performing the SDT, the terminal may release the corresponding uplink radio resource(s) according to configuration of the base station. In the case of one-time transmission of the SDT, the terminal may release the corresponding uplink radio resource. In addition, in the transmission step of the last segment of the SDT or the one-time transmission step of the instance message, the terminal may selectively transmit control information for requesting uplink radio resource configuration together. The terminal may transmit an uplink radio resource configuration/allocation request in form of a control field of uplink physical layer control information, a MAC control message, or an RRC control message. Here, the MAC control message may be configured in form of an LCID or MAC subheader indicating an uplink radio resource request, or may be configured in form of a MAC (sub)PDU including one or more of the above-described control information for SDT.

In addition, from the RA MSG3 or the uplink control message (e.g., MAC CE or RRC message) after the RA MSG3 transmitted by the terminal for the uplink SDT, the base station may obtain information such as information on whether the SDT is performed as being segmented (or whether the SDT is performed as one-time transmission), the size of the uplink SDT (e.g., the size of the MAC PDU or RRC message, etc.), and/or the number of messages for the uplink SDT. Here, the uplink control message after the RA MSG3 that deliver the information indicating whether the SDT is performed as being segmented (or whether the SDT is performed as one-time transmission) may refer to an uplink message transmitted first after the RA MSG3. The base station obtaining the information may transmit allocation (or scheduling) information for uplink radio resources for two or more segmented SDTs to the terminal rather than one-time transmission (or one-shot transmission). In this case, the allocation (or scheduling) information for uplink radio resources after the RA MSG3 may be transmitted in form of uplink grant information in an RA MSG 4 or a separate MAC (sub)header and/or MAC CE, or may be transmitted in form of a physical layer control channel (PDCCH or DCI). When the allocation (or scheduling) information for uplink radio resources is transmitted through a physical layer control channel (PDCCH or DCI), the allocation (or scheduling) information for uplink radio resources may be transmitted to the terminal through resources of a CORESET configured for uplink SDT.

As a method of classifying random access radio resource groups for SDT, a method of classifying and configuring indices of random access occasions (ROs) and/or RA preambles may be considered. That is, in the radio resource configuration of random access occasions, the uplink radio resource(s) used for the RA procedure not for SDT and the uplink radio resource(s) used for the RA procedure for SDT may be configured as being separated. In addition, indices of the RA preambles for SDT may be configured as being separated. The base station may configure one or more RA preamble (RA MSG1) resource groups selectable according to the size of the uplink SDT and/or a channel quality of a radio link (path loss, RSRP, RSRQ, etc.). That the random access radio resources for SDT are configured differently may mean that the terminal transmit the RA preambles or RA payloads by configuring different positions or indices of radio resources in the time domain or frequency domain, indices of RA preambles, transmission timings, or offset values.

When the RA MSG3 of the step S604 includes the above-described terminal identifier, uplink data, or control signaling information, control fields for indicating the property or the length of the uplink data and control signaling information, or whether the corresponding control information is included may be configured in form of a MAC subheader, a MAC header, or a logical channel identifier (e.g., LCID), or a MAC control element (CE).

Using the RA procedure of FIG. 6 described above, the terminal may perform a procedure for transmitting an intermittently occurring uplink SDT. When uplink SDT is required, the terminal in the inactive state or the idle state may trigger the RA procedure (or operation) according to FIG. 6. That is, if the condition(s) preconfigured for the intermittent uplink SDT is satisfied, the terminal may perform the step S602 by selecting an RA MSG1 satisfying the above-described condition.

In this case, the base station may separately configure the RO configuration parameter(s) and/or the RA MSG1 for the intermittent uplink SDT. The base station may separately configure the RO configuration parameter(s) and/or RA MSG1 according to the size or type (or form) of the uplink message to be transmitted by the terminal and/or the channel quality of the radio link. Upon receiving the RA MSG1 for SDT, the base station may transmit the RA response message by performing the step S603 of FIG. 6. The RA response message may include allocation information for an uplink radio resource for RA MSG3 transmission. The terminal may perform the generated uplink SDT by using the uplink radio resource allocated for the RA MSG3. The RA response message for the RA MSG1 transmitted by the terminal for SDT and an RA response message (RA MSG2) for an RA procedure for other purposes may differ in formats (or configuration of parameters). That is, the response message (RA MSG2) for the RA MSG1 transmitted by the terminal for SDT may include uplink radio resource allocation information for SDT.

In this case, the MAC subheader for the RA MSG2 may include field parameter (or indicator) information indicating that the corresponding RA MSG2 is the RA MSG2 according to the 4-step RA procedure for SDT. For example, a corresponding indicator (or bit) set to ‘1’ may indicate that the RA MSG2 includes uplink radio resource allocation information for SDT, or that the RA MSG2 is the RA MSG2 of the 4-step RA procedure performed for SDT. The corresponding indicator (or bit) set to ‘0’ may indicate that the RA MSG2 does not include uplink radio resource allocation information for SDT, or that the RA MSG2 is an RA MSG2 of a 4-step RA procedure performed for a purpose other than SDT.

In addition, the RA MSG2 of the 4-step RA procedure performed for SDT may include the terminal identifier for SDT, transmission power adjustment information (e.g., TPC), PUCCH resource indicator, transmission timing adjustment information (e.g., timing advance command), MCS index, and/or uplink radio resource allocation information (or PUSCH resource indicator) for SDT. Here, the terminal identifier for SDT may be an identifier assigned to the terminal to identify the terminal in the inactive state, I-RNTI of the 3GPP NR system, a terminal identifier in an RRC resume request message (e.g., resumeIdentity, I-RNTI, or ShortI-RNTI of the 3GPP NR system, etc.).

The base station may estimate the size or type (or form) of the uplink message to be transmitted by the terminal and/or the level of the channel quality of the radio link based on the RA MSG1 received from the terminal, and transmit allocation information of an uplink radio resource for transmission of the RA MSG3 to the terminal as an RA response message. That is, the base station may determine the size and/or MCS level of the uplink radio resource for transmission of the RA MSG3 in consideration of the size or type (or form) of the uplink message of the terminal and/or the radio link channel quality indicated by the RA MSG1 received from the terminal, and transmit the allocation information of the corresponding uplink radio resource to the terminal by using the RA response message.

As another method, the base station may transmit uplink scheduling information for transmission of an uplink SDT to the terminal within a preconfigured time period (e.g., a time window (or period) preconfigured when the step S602 is performed). The uplink scheduling information may be transmitted on a physical layer control channel (PDCCH). In this case, a scheduling identifier may be RA-RNTI or RTNI for SDT (e.g., IM-RNTI). The IM-RNTI may be used when transmitting scheduling information for uplink SDT. Accordingly, the terminal may obtain the uplink scheduling information from the RA MSG2 received by using the RA-RNTI and/or a PDCCH or PDSCH received by using the IM-RNTI. That is, the uplink scheduling information for SDT may be delivered to the terminal using a PDCCH or PDSCH resource. Accordingly, the terminal may perform the uplink SDT occurring in the terminal by using the uplink radio resource allocated based on the corresponding uplink scheduling information.

When the RA MSG1 for the uplink SDT is not separately configured, the terminal having transmitted the RA MSG1 may receive the RA response message of the step S603 according to the procedure of FIG. 6. Thereafter, the terminal may transmit the RA MSG3 including the above-described control information for SDT to the base station. The RA MSG3 may include a terminal identifier for SDT, and the terminal identifier for SDT may be an identifier assigned to the terminal to identify the terminal in the inactive state, I-RNTI of the 3GPP NR system, or a terminal identifier in an RRC resume request message (e.g., resumeIdentity, I-RNTI, ShortI-RNTI, etc. of the 3GPP NR system).

The base station may determine whether to transition the state of the terminal based on the above-described BSR information, information indicating the size of the uplink SDT, information indicating whether the uplink SDT satisfies a reference condition, or information on the desired state of the terminal after the SDT is completed, which is received through the RA MSG3 of the step S604 or the control message (e.g., MAC layer or RRC control message, etc.) after completion of the RA procedure of FIG. 6. For example, if the terminal satisfies a reference condition for transmitting uplink data in the inactive or idle state without transitioning to the connected state, the base station may control the terminal to perform the SDT in the inactive state or control the terminal to transition to the inactive state or idle state after the SDT is performed.

When the terminal requests transmission of a message larger than a reference condition (or threshold), the base station may control the terminal to transition to the connected state and transmit the corresponding message. In addition, when determining that it is necessary, the base station may indicate or control the terminal performing the RA random access procedure to transition to the connected state or inactive state to perform uplink transmission or downlink reception operation by using the response message or a separate control message.

The base station may transmit the scheduling information of the uplink radio resource to the terminal in the step S604 or after the step S604 so that the terminal can perform the uplink SDT. The uplink scheduling information may be transmitted on a PDCCH or PDSCH. In this case, a scheduling identifier may be a C-RNTI included in the RA response message of the step S603 or an RTNI for SDT (e.g., IM-RNTI). Here, the IM-RNTI means a scheduling identifier assigned to the terminal (or terminal group) for SDT. In addition, one of scheduling identifiers uniquely assigned to a specific terminal (e.g., C-RNTI, SPS-RNTI, CS-RNTI, TPC RNTI, INT-RNTI, SFI-RNTI) may be used as the RNTI for SDT (i.e., IM-RNTI), or a group scheduling identifier (or multicast scheduling identifier) assigned to a terminal group may be configured and used as the RNTI for SDT (i.e., IM-RNTI). That is, the corresponding group scheduling identifier may be configured as the scheduling identifier for SDT while performing a role of a scheduling identifier assigned to the terminal (or terminal group).

In the RA procedure for SDT, when the base station transmits the RA response message using the RNTI for SDT or transmits the scheduling information for SDT, the corresponding PDCCH (or DCI) may include uplink radio resource allocation information for SDT.

The terminal may perform the uplink SDT by using the uplink radio resource allocated based on the corresponding uplink scheduling information. In addition, when the control information transmitted by the terminal in the step S604 is transmitted through a MAC layer message, whether the corresponding control information exists and/or values (or, ranges of configuration parameters) of the control information may be delivered in form of a MAC (sub)header or MAC (sub)PDU. For this, a separate logical channel identifier (LCID) may be configured.

Uplink SDT Method Using 2-Step RA Procedure

FIG. 7 is a sequence chart illustrating an SDT method based on a 2-step random access procedure according to an exemplary embodiment of the present disclosure.

Referring to FIG. 7, a communication system may include a base station, a terminal, and the like. The base station may be the base station 110-1, 110-2, 110-3, 120-1, or 120-2 shown in FIG. 1, and the terminal may be the terminal 130-1, 130-2, 130-3, 130-4, 130-5, or 130-6 shown in FIG. 1. The base station and the terminal may be configured to be the same or similar to the communication node shown in FIG. 2. A random access procedure may be performed in two steps.

The base station may transmit system information and/or a control message including configuration information of a radio resource (e.g., uplink radio resource) for the random access procedure to the terminal (S701). The terminal may obtain the configuration information of the radio resource for the random access procedure by receiving the system information and/or the control message from the base station. Here, the control message may be a dedicated control message. The system information and/or dedicated control message may be the same as or similar to the system information and/or dedicated control message in the step S601 shown in FIG. 6.

The terminal may transmit an RA MSG-A to the base station using the radio resource configured by the base station (S702). The RA MSG-A may include an RA preamble and a terminal identifier (e.g., UE ID, C-RNTI). Here, the UE ID transmitted using the RA MSG-A may be a terminal identifier for SDT, and the terminal identifier for SDT may be an identifier assigned to the terminal to identify the terminal in the inactive state, I-RNTI of the 3GPP NR system, or a terminal identifier in an RRC resume request message (e.g., resumeIdentity, I-RNTI, ShortI-RNTI, etc. of the 3GPP NR system).

In addition, the RA MSG-A may further include uplink data and/or control information. In the 2-step random access procedure, a message 1 may be referred to as the ‘RA MSG-A’ or ‘MSG-A’, and the RA MSG-A may be distinguished from the RA MSG1 in the 4-step random access procedure.

The RA MSG-A may include an RA preamble and an RA payload. In the 2-step random access procedure, the RA preamble may be referred to as a ‘2-step-RA preamble’, and in the 2-step random access procedure, the RA payload may be referred to as a ‘2-step-RA payload’. The RA preamble of the RA MSG-A may be selected by the MAC layer of the terminal. The RA payload of the RA-MSG-A may be generated by the MAC layer or the RRC layer. The RA preamble selected by the MAC layer of the terminal and the RA payload generated by the MAC layer or RRC layer of the terminal may be delivered to the physical layer. The RA payload of the RA MSG-A may include one or more among the terminal identifier (e.g., UE ID, C-RNTI), uplink data, and control information. The base station may configure the following random access parameters or configuration information selectively applied according to the size of the uplink SDT and/or the channel quality of the radio link (path loss, RSRP, or RSRQ, etc.), and the terminal may obtain the information in the step S701.
Group configuration information of one or more MSG-A RA preamble resources according to the size of the SDT and/or the channel quality of the radio link, and/or
Group configuration information (e.g., MCS configuration list or range) of one or more MCS levels to be applied to the RA payload according to the size of the SDT and/or the channel quality of the radio link

Depending on the size of the uplink SDT and/or the channel quality of the radio link, the terminal may select the MSG-A RA preamble and/or an MCS level to be applied to the MSG-A RA payload satisfying the condition. When the MSG-A RA preamble resources and MCSs to be applied to the MSG-A RA payload according to the size of the SDT and/or the channel quality of the radio link have a mapping or association relationship, if the terminal select the MSG-A RA preamble satisfying the condition according to the size of the uplink SDT and/or the channel quality of the radio link, the MCS level to be applied to the MSG-A RA payload may be determined according to the selected MSG-A RA preamble.

Information on the selected RA preamble and the generated RA payload may be delivered to the physical layer, and the RA MSG-A including the selected RA preamble and the generated RA payload may be transmitted to the base station (S702). The RA payload of MSG-A may include a terminal identifier (e.g., UE ID or C-RNTI, etc.), uplink data (or SDT packet), a logical channel identifier (LCI) for identifying a bearer for SDT (data radio bearer (DRB) or signaling radio (SRB) bearer), or control signaling information. Here, the control signaling information may include a BSR, measurement result information (e.g., quality information), BFR request information, RLF report information, request information of RRC connection setup, request information of RRC connection re-establishment, resume request information, and transmission request information of system information. When the CBRA procedure or the CFRA procedure is performed, the RA payload may include the terminal identifier. The uplink radio resource for transmission of the RA preamble may be configured independently of the uplink radio resource for transmission of the RA payload.

For example, the radio resources configured (or allocated) for the radio access procedure may be non-contiguous in the time domain or frequency domain. Alternatively, the radio resources configured (or allocated) for the radio access procedure may be contiguous in the time domain or frequency domain. The radio resources for the radio access procedure may be radio resources configured (or allocated) in different schemes. Alternatively, the radio resources for the radio access procedure may be radio resources defined by different physical layer channels.

The expression that the radio resources for the radio access procedure are different may mean that one or more among the positions of the radio resources in the time domain or frequency domain, indices of the radio resources, indices of the RA preambles, transmission timings, and offsets are configured differently. The RA preamble or RA payload may be transmitted using different radio resources. For example, the RA preamble may be transmitted on a PRACH, and the RA payload may be transmitted on a physical uplink shared channel (PUSCH).

In order to configure the transmission resource for the RA preamble of the RA MSG-A differently from the transmission resource for the RA payload of the RA MSG-A, the uplink radio resource for transmission of the RA payload of the RA MSG-A (e.g., PUSCH configured for transmission of the RA payload of the RA MSG-A) may be configured to correspond to the RA preamble of the RA MSG-A. That is, a mapping relationship between the uplink radio resource for transmitting the RA preamble of the RA MSG-A and the uplink radio resource for transmitting the RA payload of the RA MSG-A may be configured.

For example, the transmission resource of the RA preamble may be mapped one-to-one with the transmission resource of the RA payload. In this case, one PRACH may be mapped to one PUSCH. Alternatively, a plurality of transmission resources of the RA preamble may be mapped to one transmission resource of the RA payload. In this case, a plurality of PRACHs may be mapped to one PUSCH. Alternatively, one transmission resource of the RA preamble may be mapped to a plurality of transmission resources of the RA payload. In this case, one PRACH may be mapped to a plurality of PUSCHs. In order to improve the reception quality of the RA payload, the RA payload may be repeatedly transmitted. The uplink radio resources for the repetitive transmission of the RA payload may be configured, and the corresponding uplink radio resources may be mapped to the transmission resources of the RA preamble.

For example, when the transmission resource of the RA MSG-A is preconfigured or when the RA preamble of the RA MSG-A is transmitted through a preconfigured region (or group), the base station may configure radio resources for the repetitive transmissions of the RA payload of the RA MSG-A. Therefore, when a coverage expansion function is applied or when a preconfigured reference condition is satisfied, the terminal may select RA preamble resources or RA preamble index for the repetitive transmissions of the RA payload, and may repeatedly transmit the RA payload based on the selected resource or index. The terminal may repeatedly transmit the RA payload using uplink radio resources mapped to the RA preamble index. The uplink radio resources (e.g., repeated radio resources) for transmission of the RA payload may be configured within a preconfigured period in the frequency domain or time domain. Information on a mapping relationship of the uplink radio resources for transmission of the RA MSG-A may be transmitted to the terminal through system information and/or an RRC message.

When the 2-step random access procedure is performed in a non-contention scheme, the transmission resources of the RA preamble and/or the RA payload of the RA MSG-A may be allocated dedicatedly to the terminal. In the CFRA procedure, resource information of the RA preamble configured dedicatedly for the terminal may include an SS/PBCH resource list, a CSI-RS resource list, an SS/PBCH index, a CSI-RS index, an RA preamble index, and the like. The transmission resource of the RA payload of the RA MSG-A may be determined based on the mapping relationship (e.g., one-to-one mapping relationship or many-to-one mapping relationship) between the transmission resource of the RA preamble and the transmission resource of the RA payload. In the CFRA procedure (e.g., 2-step CFRA procedure), the resource information of the RA payload configured dedicatedly for the terminal may include allocation information of an uplink radio resource, beam configuration information, MCS information, etc. for transmission of the RA payload.

In the 2-step RA procedure, the transmission resource of the RA preamble may be contiguous with the transmission resource of the RA payload in the time domain. Alternatively, the transmission resource of the RA preamble and the transmission resource of the RA payload may be allocated within a time window. The terminal performing the 2-step RA procedure may transmit the RA payload using the transmission resource of the RA payload, that is contiguous with the transmission resource of the RA preamble. Alternatively, the terminal may transmit the RA payload using an RA payload transmission resource within a preconfigured time window.

Alternatively, parameter(s) for allocation of the transmission resource of the RA preamble and the transmission resource of the RA payload may include a frequency offset and/or a time offset. Accordingly, the terminal may transmit the RA payload using the radio resource for the RA payload mapped to the RA preamble. Alternatively, the terminal may randomly select one or more radio resources among radio resources configured for transmission of the RA payload, and may transmit the RA payload using the selected radio resource(s).

The RA payload of the RA MSG-A transmitted in the step 702 may be configured to be the same or similar to the RA MSG3 transmitted in the step S604 shown in FIG. 6. For example, the RA payload of the RA MSG-A may include one or more among the identifier, capability, property, mobility state, and position information of the terminal, a cause for attempting the access procedure, request information of beam failure recovery, measurement result on a base station (or cell) in the CA environment, request information of activation/deactivation of the CA, BWP switching request information, BWP deactivation/activation request information, uplink data (e.g., SDT packet), size of the uplink data (e.g., SDT packet), uplink buffer size information (e.g., BSR), control message for requesting connection configuration, information indicating whether the size of the uplink SDT satisfies a preconfigured condition, request information of uplink resource allocation, and a measurement result of a radio channel. The control information for uplink SDT included in the RA MSG3 shown in FIG. 6 may be included in the RA payload of the RA MSG-A in FIG. 7. That is, the terminal may transmit the RA payload including control information for uplink SDT to the base station. That is, for uplink SDT, the terminal may transmit information indicating whether the SDT is performed as segmented (or whether the SDT is performed as one-time transmission) together by using the MSG-A RA payload. Depending on whether the SDT is performed as segmented, the terminal may transmit a separate control message (e.g., MAC layer and/or RRC layer control message) in addition to the SDT. For example, when the segmented transmission of the SDT is applied, the terminal may deliver one or more among uplink radio resource request information for the transmission of segmented SDTs and/or the size of the uplink SDT (e.g., the size of the MAC PDU or RRC message, etc.), the number of messages for the uplink SDT (e.g., the number of the MAC PDUs or RRC messages, etc.), uplink buffer size information (e.g., BSR), a control message for connection configuration request, indication information indicating whether the size of the uplink SDT satisfies a preconfigured condition, information such as a radio channel measurement result, or a desired operation state of the terminal after completion of the SDT. When the control information is transmitted as a MAC layer message, whether the corresponding control information exists and/or value(s) (or configuration parameter range(s)) of the control information may be delivered in form of a MAC (sub)header or a MAC (sub)PDU. For this, a separate logical channel identifier (LCID) may be configured.

When it is determined (or confirmed) that segmented transmission is applied based on the control information received from the terminal, the base station may allocate uplink radio resources and/or CG resources for the segmented transmission of the SDT to the terminal. In this case, frequency-domain configuration information of uplink radio resources and/or CG resources for SDT and time-domain configuration information such as a transmission start time and/or transmission end time, an SDT transmission period (or window, timer, counter), or a transmission periodicity within the transmission period may be delivered to the terminal. Here, the SDT transmission period (or window, timer, counter) may be a period in which radio link management for SDT and resource allocation (or scheduling) for SDT are valid for the corresponding terminal (or group), or a timer for determining whether the SDT has been successfully performed. The time-domain configuration information may be configured in units of radio frames, subframes, slots, minislots, or symbols.

By using the uplink radio resource(s) for SDT allocated from the base station, the terminal may perform the SDT by segmenting it or perform the SDT as one-time transmission. After performing the SDT, the terminal may release the corresponding uplink radio resource(s) according to configuration of the base station. In the case of one-time transmission of the SDT, the terminal may release the corresponding uplink radio resource. In addition, in the transmission step of the last segment of the SDT or the one-time transmission step of the SDT, the terminal may selectively transmit control information for requesting uplink radio resource configuration together. The terminal may transmit an uplink radio resource configuration/allocation request in form of a control field of uplink physical layer control information, a MAC control message, or an RRC control message. Here, the MAC control message may be configured in form of an LCID or MAC subheader indicating an uplink radio resource request, or may be configured in form of a MAC (sub)PDU including one or more of the above-described control information for SDT.

When the terminal identifier, uplink data, or control signaling information is transmitted in the step S702 through the radio resource for transmission of the MSG-A RA payload together with the RA preamble, control fields indicating the property or length of the corresponding uplink data and the corresponding control signaling information or information whether the corresponding control information is included may be configured in form of a MAC header, logical channel identifier (e.g., LCID), or MAC CE.

In the step S702, for transmission timing adjustment (e.g., timing advance (TA)) or transmission power control of the terminal, the terminal may transmit the RA payload of the MSG-A by inserting a preamble, pilot symbol, or reference signal (e.g., RS) in a first symbol or some symbols constituting the RA payload of the MSG-A.

The base station receiving the identifier of the terminal and uplink data or control signaling information transmitted by the terminal through the MSG-A of the step S702 may generate and transmit an RA response message (hereinafter, RA MSG-B) (S703). The RA MSG-B may include a backoff indicator (BI), uplink radio resource allocation information, information indicating the RA preamble of the received RA MSG-A, transmission timing adjustment information (TA) of the terminal, scheduling identifier (C-RNTI or Temporary C-RNTI, etc.), and/or a terminal identifier (hereinafter referred to as a contention resolution ID (CRID)) for contention resolution.

If the MSG-B is scheduled by the C-RNTI allocated to the terminal in the 2-step RA procedure or a CRID transmitted through the MSG-A is included in the MSG-B, the base station may determine that contention has been resolved. In particular, when the base station transmits scheduling information of a PDSCH including the MSG-B (or RA response message for the MSG-A) by using the C-RNTI, if the terminal receives the MSG-B (i.e., RA response) including the TA information and uplink grant information within the RA response window (or before a related timer expires), the terminal may determine that contention resolution for the MSG-A transmitted by the terminal has been completed. In this case, in order to clarify that the MSG-B scheduled by the C-RNTI is a response to the 2-step RA procedure according to the MSG-A transmitted by the terminal, a field (or bit) in a PDCCH (e.g., DCI or UCI) may be used to indicate that the MSG-B scheduled by the corresponding PDCCH is an RAR. Alternatively, information of a field of a MAC subheader or a logical channel identifier (LCID) for transmission of a MAC CE for the RAR may be used to indicate that the MSG-B scheduled by the C-RNTI is a response to the 2-step RA procedure according to the MSG-A transmitted by the terminal. Here, in the 4-step RA procedure, the RA response window may start when the transmission of the RA MSG1 is completed, and in the 2-step RA procedure, the RA response window may start when the transmission of the RA payload of the MSG-A is completed. Therefore, if the terminal does not receive the MSG-B (i.e., RA response) including TA information or uplink grant information scheduled by the C-RNTI within the RA response window (or before the related timer expires), it may be determined that the contention resolution for the 2-step RA procedure according to the MSG-A transmitted by the terminal has failed. If the MSG-B scheduled by the C-RNTI is transmitted in response to the 2-step RA procedure according to the MSG-A transmitted by the terminal, a PDCCH (e.g., DCI or UCI) including an indicator indicating that scheduling information for the RA response to the MSG-A is included along with TA information may be transmitted.

The RA MSG-B may be generated in form of a MAC control message (e.g., MAC CE) of the MAC layer of the base station and/or in form of an RRC control message of the RRC layer of the base station. When the RA MSG-B is generated in form of a MAC CE, the RRC layer, which received information on the received MSG-A, may deliver control parameters to be included in the RA MSG-B to the MAC layer, and the MAC layer may generate (or, configure) the RA MSG-B in form of a MAC CE. In the step S703, the base station may transmit the identifier of the terminal received through the RA payload of the MSG-A by including it in the RA MSG-B.

When the RA preamble of the MSG-A is dedicatedly allocated to the terminal, or the radio resources for transmission of the RA preamble and the RA payload of the MSG-A have a predetermined mapping relationship, the RA response message of the step S703 may not include information on the index of the RA preamble transmitted by the terminal.

When the RA preamble of the MSG-A is dedicatedly allocated to the terminal, or when the RA payload including the scheduling identifier (e.g., C-RNTI) allocated to the terminal is received, the base station may transmit scheduling information (e.g., PDCCH) of a physical radio resource for transmission of the RA MSG-B by using the corresponding scheduling identifier.

In the step S703, the base station may transmit only a PDCCH for allocating an uplink radio resource, transmit only a PDCCH (e.g., DCI type) for RA response, or transmit a random access response message on a PDSCH. In the case that only the PDCCH allocating an uplink radio resource is transmitted in the step S703, the corresponding DCI may include one or more among uplink resource allocation information (e.g., scheduling information), transmission timing adjustment information (e.g., a timing advance (TA) value, a TA command), transmission power adjustment information, backoff information, beam configuration information or TCI state information, configured scheduling (CS) state information, state transition information, PUCCH configuration information, index of the MSG-A received in the step S702, and uplink resource allocation information for transmission of the RA payload of the MSG-A. Here, the beam configuration information may be information indicating activation or deactivation of a specific beam. The TCI state information may be information indicating activation or deactivation of a specific TCI state. The CS state information may be information indicating activation or deactivation of a radio resource allocated in the CS scheme. The state transition information may be information indicating transition of the operation state of the terminal shown in FIG. 5. The state transition information may indicate transition from a specific operation state to the RRC idle state, the RRC connected state, or the RRC inactive state. Alternatively, the state transition information may indicate maintaining of the current operation state. The PUCCH configuration information may be allocation information of a scheduling request (SR) resource. Alternatively, the PUCCH configuration information may be information indicating activation or deactivation of an SR resource.

In addition, the base station may transmit only the above-described PDCCH and transmit the control information by using a PDSCH radio resource in the step S703. That is, the base station may generate and transmit the uplink radio resource allocation (or scheduling) information, transmission timing adjustment information, transmission power adjustment information, backoff information, beam configuration or TCI state information, configured scheduled (CS) state information, state transition information, PUCCH configuration information, index of the RA preamble of the MSG-A transmitted by the terminal in the step S702, or uplink radio resource allocation information for the terminal to transmit a message in a step S704.

The base station may transmit only the PDCCH for RA response in the step S703. In this case, the control information may be transmitted through a PDSCH. That is, the control information may include one or more among uplink resource allocation information (e.g., scheduling information), transmission timing adjustment information (e.g., TA value, TA command), transmission power adjustment information, backoff information, beam configuration information or TCI state information, configured scheduling (CS) state information, state transition information, PUCCH configuration information, index of the RA preamble of the MSG-A received in the step S702, and uplink resource allocation for transmission of the RA MSG-B in the step S704.

For the generation and transmission of the RA MSG-B in the step S703, the base station may transmit the PDCCH including scheduling information for transmission of the RA MSG-B by using the RA-RNTI or the scheduling identifier (C-RNTI) allocated to the terminal. The random access response message (i.e., RA MSG-B) may be transmitted using a PDSCH resource addressed by the scheduling information in the corresponding PDCCH.

When the terminal successfully receives the RA MSG-B of the step S703 transmitted by the base station, the 2-step RA procedure is terminated. In addition, the terminal receiving the RA MSG-B of the step S703 may generate and transmit uplink data or a control message by using the uplink scheduling information transmitted by the base station (S704).

The base station may notify the terminal of information on whether the base station (or cell) allows the 2-step RA procedure or control information such as a condition for the terminal to attempt the 2-step RA procedure by using system information transmitted in a broadcast scheme, control signaling transmitted in a multicast scheme, or a dedicated control message. Here, the information on whether the 2-step RA procedure is allowed refers to information on whether the base station allows or restricts (or partially prohibits) an access attempt using the 2-step RA procedure to the terminal(s) within the service coverage. When the 2-step RA procedure is restricted, information on a condition for which the 2-step RA procedure is restricted or partially prohibited may be transmitted to the terminal. If the base station (or cell) does not allow the 2-step RA procedure or the condition for restricting (or partially prohibiting) the 2-step RA procedure is satisfied, the terminal may not attempt the 2-step RA procedure.

The information on the condition under which the terminal can attempt the 2-step RA procedure is information for allowing the terminal to perform the 2-step RA procedure only when the corresponding condition is satisfied. For example, the terminal may be controlled to perform the 2-step RA procedure only when the quality of the radio channel measured by the terminal satisfies a reference condition (or threshold) configured by the base station using the above control information. Here, the quality of the radio channel may be, for example, a received signal strength indicator (RSSI), received signal code power (RSCP), reference signal received power (RSRP), or reference signal received quality (RSRQ). Alternatively, the quality of the radio channel is a reference parameter for measuring a quality of a radio section between the base station (or cell, TRP, etc.) and the terminal. The RA preamble (or signature) of the RA MSG1 for the 4-step RA procedure and the RA preamble (or signature) of the MSG-A for the 2-step RA procedure may be configured identically. That is, code sequences generated using the same code generation formula may be used as the RA preamble (or signature) of the RA MSG1 for the 4-step RA procedure and the RA preamble of the MSG-A for the 2-step RA procedure. However, in this case, the uplink physical layer radio resource for transmission of the RA preamble or the RA preamble index used by the terminal in the 2-step RA procedure may be configured differently from the uplink physical layer radio resource for transmission of the RA preamble or the RA preamble index used by the terminal in the 4-step RA procedure. As a method of configuring different uplink physical layer radio resources, a method of configuring the RA radio resources differently in the time domain or in the frequency domain, or a method of configuring the RA radio resources differently in the time domain and frequency domain may be used. In the frequency domain, the radio resource may be configured with an indicator or index for identifying a frequency band, band, subcarrier, or beam according to a beamforming technique. In the time domain, the radio resource may be configured with an indicator, index, or number for identifying a transmission (or reception) time unit(s) (or periodicity, period, window) such as a radio frame, subframe, transmission time interval (TTI), slot, mini-slot, or symbol. Therefore, the base station may determine whether the corresponding RA preamble is an RA preamble for the 2-step RA procedure or an RA preamble for the 4-step RA procedure only by receiving the RA preamble transmitted by the terminal or only by the uplink physical layer resource used by the terminal for transmission of the RA preamble.

Using the above-described 2-step RA procedure, the terminal may perform a procedure for performing an intermittently occurring uplink SDT. When an uplink SDT is required, the terminal in the inactive state or idle state may trigger an operation for transmission of the MSG-A according to FIG. 7. That is, when a condition preconfigured for performing an intermittently occurring uplink SDT is satisfied, the terminal may perform the step S702 for transmission of the MSG-A satisfying the above-described condition. In this case, the terminal transmits the RA payload of the MSG-A including control information for the uplink SDT.

That is, one or more among the above-described uplink SDT request (or transmission) indication information and/or the size of the uplink SDT (e.g., the size of the MAC PDU or RRC message), indicator indicating the range of the size of the uplink SDT, number of messages for the uplink SDT (e.g., the number of the MAC PDUs or RRC messages), uplink buffer size information (e.g., BSR), control message for requesting connection configuration, information indicating whether the size of the uplink SDT satisfies a preconfigured condition, uplink radio resource allocation request information, radio channel measurement result, and information on the desired terminal state after the transmission of the uplink SDT is completed may be included in the RA payload of the MSG-A. When the control information is transmitted as a MAC layer message, whether the corresponding control information exists and/or a control information value (or configuration parameter range) may be delivered in form of a MAC (sub)header or a MAC (sub)PDU. For this, a separate logical channel identifier (LCID) may be configured.

As a method of classifying random access radio resource groups for SDT, a method of classifying and configuring indices of random access occasions (ROs) for transmission of the MSG-A and/or RA preambles of the MSG-A may be considered. That is, in the radio resource configuration of random access occasions, the MSG-A radio resource(s) used for the RA procedure not for SDT and the MSG-A radio resource(s) used for the RA procedure for SDT may be configured separately. In addition, indices of the RO configuration parameters and/or RA preambles of the MSG-A for SDT may be configured separately. The base station may select the RO configuration parameter and RA preamble of the MSG-A according to the size or type (or form) of the uplink SDT and/or the channel quality of the radio link (path loss, RSRP, RSRQ, etc.).

That the random access radio resources for SDT are configured differently may mean that the terminal transmits the RA preambles or RA payloads by differently configuring positions or indices of the uplink radio resources (e.g., radio resources in the time domain and/or frequency domain) for the MSG-A preambles and/or MSG-A payloads, indices of the RA preambles, transmission timings, or offset values.

The configuration or format of the RA payload of the MSG-A for SDT may be different from the configuration or format of the RA payload of the MSG-A for a general RA procedure. That is, the base station may configure a radio resource for the RA payload of the MSG-A for SDT to be larger than a radio resource for the RA payload of the MSG-A for a general RA procedure so that an SDT larger than a message (or transport block) transmitted as the RA payload of the MSG-A for a general RA procedure can be performed. Accordingly, the terminal may transmit information indicating an SDT in the configuration or format of the RA payload of the MSG-A for SDT. Based on the indication information, the RA payload of the MSG-A for SDT may be distinguished from the RA payload of the MSG-A for a purpose other than SDT.

After the reception of the MSG-A of the step S702 or completion of the RA procedure, the base station may determine whether to transition the state of the terminal based on the above-described BSR information, the size (or size range) of the uplink SDT, or the information indicating whether the reference condition is satisfied, which is received from the terminal through a control message (e.g., MAC layer or RRC control message, etc.). For example, if a reference condition for the terminal in the inactive or idle state to transmit uplink data without transitioning to the connected state is satisfied, the base station may control the terminal to transmit the corresponding message in the inactive state or to transition to the inactive state or idle state after transmitting the corresponding message.

In addition, from the RA payload of the MSG-A transmitted by the terminal for the transmission of the uplink SDT, the base station may obtain information such as information on whether the SDT is performed as segmented (or whether the SDT is performed as one-time transmission), the size of the uplink SDT (e.g., the size of the MAC PDU or RRC message, etc.), and/or the number of messages for the uplink SDT. The base station obtaining the information may transmit allocation (or scheduling) information for uplink radio resources for transmission of two or more segmented SDTs to the terminal rather than one-time transmission (or one-shot transmission). In this case, the allocation (or scheduling) information for uplink radio resources after the RA payload of the MSG-A may be transmitted in form of uplink grant information in the MSG-B or a separate MAC (sub)header and/or MAC CE, or may be transmitted in form of a physical layer control channel (PDCCH or DCI). When the allocation (or scheduling) information for uplink radio resources is transmitted through a physical layer control channel (PDCCH or DCI), the allocation (or scheduling) information for uplink radio resources may be transmitted to the terminal through resources of a CORESET configured for uplink SDT.

When the 2-step RA procedure is performed for SDT, the format (or parameter configuration) of the response message (RA MSG-B) for the RA MSG-A transmitted by the terminal may be different from the format (or parameter configuration) of the RA response message (RA MSG-B) for other purposes. That is, the response message (RA MSG-B) for the RA MSG-A transmitted by the terminal for SDT may include allocation information for an uplink radio resource for SDT.

In this case, the MAC subheader for the RA MSG-B may include field parameter (or indicator) information indicating that the corresponding RA MSG-B is the RA MSG-B according to the 2-step RA procedure for SDT. For example, a corresponding indicator (or bit) set to ‘1’ may indicate that the RA MSG-B includes uplink radio resource allocation information for SDT, or that the RA MSG-B is the RA MSG-B of the 2-step RA procedure performed for SDT. The corresponding indicator (or bit) set to ‘0’ may indicate that the RA MSG-B does not include uplink radio resource allocation information for SDT, or that the RA MSG-B is an RA MSG-B of a 2-step RA procedure performed for a purpose other than SDT.

In addition, the RA MSG-B of the 2-step RA procedure performed for SDT may include the terminal identifier for SDT, transmission power adjustment information (e.g., TPC), PUCCH resource indicator, transmission timing adjustment information (e.g., timing advance command), MCS index, and/or uplink radio resource allocation information (or PUSCH resource indicator) for SDT. Here, the terminal identifier for SDT may be an identifier assigned to the terminal to identify the terminal in the inactive state, I-RNTI of the 3GPP NR system, a terminal identifier in an RRC resume request message (e.g., resumeIdentity, I-RNTI, or ShortI-RNTI of the 3GPP NR system, etc.).

When the terminal requests transmission of a message larger than a reference condition (or threshold), the base station may control the terminal to transition to the connected state and transmit the corresponding message. In addition, when determining that it is necessary, the base station may indicate or control the terminal performing the RA random access procedure to transition to the connected state or inactive state to perform uplink transmission or downlink reception operation by using the response message or a separate control message.

The base station may transmit the scheduling information of the uplink radio resource to the terminal in the step S704 or after the step S704 so that the terminal performs the uplink SDT. The uplink scheduling information may be transmitted on a PDCCH or PDSCH. In this case, a scheduling identifier may be the C-RNTI included in the MSG-B of the step S703 or the above-described RTNI for SDT (e.g., IM-RNTI). The terminal may perform the uplink SDT using an uplink radio resource allocated by the corresponding scheduling information.

When the uplink SDT is performed based on the above-described RA procedure, the size of the RA MSG3 or the RA payload of the MSG-A performing the SDT may be different from the size of the RA MSG3 or the RA payload of the MSG-A for general RA purposes. That is, according to the size of the SDT that the terminal intends to perform and/or the channel quality (e.g., CSI level, RSRP, RSRQ, or path loss, etc.) of the radio link measured (or estimated) by the terminal, the size of the RA MSG3 or the RA payload of the MSG-A for performing the SDT may be variably configured. Accordingly, random access parameters for SDT may be configured differently. The base station may configure available RA preamble (RA preamble of RA MSG1 or MSG-A) resources as one or more group(s) according to the size of the uplink SDT and/or the channel quality of the radio link measured by the terminal, and deliver configuration information for each group to the terminal by using system information or an RRC control message.

In addition, according to the size of the uplink SDT and/or the channel quality of the radio link measured by the terminal, the base station may configure MCS levels applicable to the RA MSG3 or the payload of the MSG-A as one or more groups, and deliver configuration information for each group to the terminal by using system information or an RRC control message. The corresponding MCS information may be configured in form of a list or range having one or more MCS values. Based on the size of the SDT to be performed and/or the measurement result of the channel quality (e.g., CSI level, RSRP, RSRQ, etc.), the terminal may select and transmit an RA preamble resource satisfying a condition among the available RA preamble (RA preambles of the RA MSG1 or the RA MSG-A) resources. In addition, based on the size of the SDT to be performed and/or the measurement result of the channel quality (e.g., CSI level, RSRP, RSRQ, etc.), the terminal may select and apply an MCS value satisfying a condition from the MCS list (or range).

When the base station does not deliver information on the MCS to be applied to the RA MSG3 or the RA payload of the MSG-A to the terminal, the terminal may select an MCS value and transmit the RA MSG3 or the RA payload of the MSG-A to which the selected MCS is applied by using SDT. In this case, the terminal may transmit information on the applied MCS (or, CG resource MCS index) by including it in the RA MSG3 or the RA payload of the MSG-A for performing the SDT. The MCS indicator transmitted by the terminal may be composed of one or more bit(s), and may be transmitted as configured as a control parameter having a fixed format in a specific radio resource region constituting the RA MSG3 or the RA payload of the MSG-A. Accordingly, the base station may acquire information on the MCS applied to the SDT from the MCS indicator of the radio resource of the RA MSG3 or the RA payload of the MSG-A received from the terminal, and perform demodulation and decoding operations according to the MCS.

As described above, the base station may configure available RA preamble (RA preamble of RA MSG1 or MSG-A) resources and/or sizes of uplink radio resources (e.g., sizes of RA MSG3 or RA payload of MSG-A) for SDT as one or more group(s) according to the size of the uplink SDT and/or the channel quality of the radio link measured by the terminal, and deliver configuration information for each group to the terminal by using system information or an RRC control message. That is, from the system information or the RRC control message, the terminal may obtain, for the uplink SDT, information on one or more RA preamble (RA preamble of RA MSG1 or MSG-A) group(s) and/or configuration information on uplink radio resources (radio resources of RA MSG3 or RA payload of MSG-A) configured based on the size of the SDT and/or the channel quality of the radio link measured by the terminal.

Accordingly, the terminal may select an RA preamble (RA preamble of RA MSG1 or RA MSG-A) corresponding to the size of the uplink SDT to be performed and/or the channel quality of the radio link measured by the terminal. In addition, the terminal may select or determine an uplink radio resource (radio resource of RA MSG3 or RA payload of MSG-A) corresponding to the size of the uplink SDT to be performed and/or the channel quality of the radio link measured by the terminal.

When the uplink SDT is performed as segmented based on the RA procedure, the base station may configure RA preamble(s) of RA MSG1 (or RA preamble(s) of RA MSG-A) for segmented transmission. In addition, the base station may allocate (or configure) a plurality of uplink radio resources for segmented transmission of the SDT continuously or discretely in the time domain and/or the frequency domain. Accordingly, the terminal may segment and perform the uplink SDT by using the plurality of uplink radio resources allocated for the segmented transmission. The uplink radio resources for the segmented transmission of the SDT may be allocated or scheduled by using at least one of the following schemes.
A scheme of allocating a plurality of uplink radio resources having a correspondence relationship with RA radio resources (ROs, RA preambles, and/or radio resources of RA payload of MSG-A) for segmented transmission of an SDT
A scheme of transmitting scheduling information for one or more uplink radio resource(s) through an RA response message (e.g., RA MSG 2 or RA MSG-B)
A scheme of transmitting scheduling information for each transmission unit of an SDT, or transmitting scheduling information for a plurality of uplink radio resources for segmented transmission of an SDT through a PDCCH using a scheduling identifier (e.g., IM-RNTI or SDT-RNTI, etc.) configured for segmented transmission of an SDT or for the SDT

In the above-described transmission method of uplink radio resource allocation (or scheduling) information for segmented transmission of an SDT, when using an RA response message, allocation (or scheduling) information of an uplink radio resource after the RA MSG3 and/or the RA payload of the MSG-A may be transmitted in form of uplink grant information in the MSG-B or a separate MAC (sub)header and/or MAC CE. In case of using a PDCCH, the uplink scheduling information for SDT may be delivered to the terminal on a PDCCH through a resource of a CORESET designated for uplink SDT.

In the above-described RA procedure-based SDT method, the uplink radio resource allocation information delivered to the terminal by using the response message (RA MSG2) for the RA MSG1, the response message (RA MSG-B) for the RA MSG-A, or the PDCCH (or IM DCI format) for SDT may include at least one among the following parameters. Here, the IM DCI format may be a format for control information for allocating (or scheduling) the uplink radio resource for SDT, which is transmitted on a PDCCH.
Uplink BWP index and/or BWP activation indicator
Downlink/Uplink beam configuration and/or TCI configuration information

The beam configuration and/or TCI configuration information, as information on a beam or TCI state for SDT, may be configured using a candidate beam list and/or an indicator for an activated TCI state.
Allocation information of a frequency-domain and/or time-domain uplink radio resource for SDT

Here, the uplink radio resource allocation information may be one-time allocation information, allocation information of a plurality of resources, and/or repetitive allocation information. In addition, the corresponding allocation information may be configured as a parameter for continuously or discretely allocating radio resources within a predetermined period.

The corresponding radio resource allocation information may be configured with a start point, end point, and/or length (or size) of a frequency-domain and/or time domain-uplink radio resource (or an index indicating the position of the radio resource).
A time period (or timer) in which the allocated uplink radio resource is valid and/or transmission timing configuration information of the allocated uplink radio resource

Here, the time period (or timer) and/or transmission timing may be configured in units of symbols, mini-slots, slots, subframes, or frames, or may be configured as an absolute time (e.g., seconds, milliseconds, etc.). The time period (or timer) may be configured with parameter(s) such as a start time, end time, duration, reference time, and/or offset, and the terminal may perform SDT by using the uplink radio resource within the time period (or until the timer expires).
Radio channel quality condition for performing SDT and/or size information of SDT

Here, when a radio channel quality condition (e.g., a condition configured as a parameter such as RSRP, RSRQ, CSI-RS, RSSI, or path loss) is satisfied, SDT may be performed with the allocated uplink radio resource.

The size information of the SDT may include a maximum size and/or a minimum size of the SDT that can be performed through the allocated uplink radio resource.
Modulation and coding scheme (MCS) configuration (or MCS level indicator) information for SDT

One or more MCS configuration(s) (or MCS level indicator(s)) may be configured, and the terminal may select an MCS satisfying the condition from among the plurality of MCSs based on the radio channel quality condition described above.

Among the above-described control information constituting the PDCCH (or IM DCI format) for SDT, parameters that are not transmitted on the PDCCH (or IM DCI format) may be transmitted to the terminal in form of a MAC CE by using a PDSCH.

When the SDT is performed as segmented as described above, each segmented SDT packet may be configured by selectively including a number indicating an order of the segmented SDT packet for reassembly, an indicator indicating a first SDT packet, an indicator indicating an intermediate SDT packet, and/or an indicator indicating a last SDT packet.

When the SDT is performed using the above-described RA procedure, the terminal may start the SDT by transmitting a resume request message through the RA MSG3 and/or the RA payload of the MSG-A. In this case, the resume request message may be transmitted by setting a resume cause within the resume request message as ‘SDT’. The resume cause in the resume request message for SDT may indicate one-time transmission or segmented transmission of the SDT. Alternatively, the resume cause in the resume request message may indicate only whether or not the SDT is performed as one-time transmission. When the resume cause in the resume request message indicates only the performing of the SDT without distinguishing between one-time transmission and segmented transmission, the terminal may transmit a scheduling request through a scheduled uplink radio resource on a physical control channel after transmitting the RA MSG3 and/or the RA payload of the MSG-A, and transmit buffer status information (BSR), information requesting segmented transmission of the SDT, and information notifying that segmented transmission or uplink resource allocation for the segmented transmission is required by using a control message (e.g., MAC CE or RRC control message). In addition, the terminal may transmit a logical channel identifier (LCID) for identifying a bearer (DRB or SRB) required for transmission of SDT packets by using a control message (or resume request message) for requesting SDT.

Even when SDT is initiated by transmitting a control message configured for requesting SDT by using the RA MSG3 and/or the RA payload of the MSG-A, the corresponding message may include information indicating the cause (or form, type) of the SDT request. The cause (or, form, type) of the SDT request in the SDT request message may indicate one-time transmission or segmented transmission of the SDT. Alternatively, the cause of the SDT request may indicate only whether or not the SDT is performed as one-time transmission. When the cause of the SDT request indicates only the transmission of the SDT without distinguishing between one-time transmission and segmented transmission, the terminal may transmit a scheduling request through a scheduled uplink radio resource on a physical control channel after transmitting the RA MSG3 and/or the RA payload of the MSG-A, and transmit buffer status information (BSR), information requesting segmented transmission of the SDT, and information notifying that segmented transmission or uplink resource allocation for the segmented transmission is required by using a control message (e.g., MAC CE or RRC control message).

RA radio resources may be configured separately as RA radio resources for the RA procedure not for SDT, and RA radio resources for the RA procedure for SDT. In the above-described two types of RA procedures, RA radio resources for the 2-step RA procedure and/or the 4-step RA procedure may be separately configured. When performing an uplink SDT by using the RA procedure, in consideration of the above-described radio channel quality condition, whether the uplink physical layer synchronization is maintained, the size condition of the SDT, whether the SDT is performed as segmented, and/or RA radio resource configuration (e.g., RO, RA preamble group, RA-MSG3, RA payload size of MSG-A, etc.), the terminal may determine which RA procedure to perform according to the following methods.

Method 1:
First step: The terminal selects one of an RA procedure not for SDT and an RA procedure for SDT.
Second step: The terminal selects the 2-step RA procedure or the 4-step RA procedure for the RA procedure selected in the first step.

Method 2:
▪ First step: The terminal selects the 2-step RA procedure or the 4-step RA procedure as an RA type for SDT.
Second step: For the RA type selected in the first step, the terminal selects one of an RA procedure not for SDT and an RA procedure for SDT.

Method 3: The terminal select one among the follows four procedure.
The 2-step RA procedure not for SDT
The 4-step RA procedure not for SDT
The 2-step RA procedure for SDT
The 4-step RA procedure for SDT

Uplink SDT Method Using a CG Resource

The terminal may perform an uplink SDT by using a CG resource. An uplink CG resource for SDT may be configured as a PUSCH resource for SDT, or may be configured as a PUSCH resource allocated to the terminal (or terminal group) in a configured grant (CG) scheme. Alternatively, an uplink CG resource for SDT may be configured similarly to the MSG-A of the step 2 RA procedure of FIG. 7. When a CG resource for SDT is configured similarly to the MSG-A, the CG resource may be configured as a PUSCH resource for performing SDT together with a bit string (or sequence) having a predetermined pattern in form of a preamble, reference signal, or pilot symbol.

In the following description, a CG resource may be configured as a PUSCH resource for SDT, configured as a PUSCH resource allocated to the terminal (or terminal group) in the CG scheme, or configured as a PUSCH for SDT and a bit string pattern of a preamble (or, reference signal, pilot symbol, etc.).

The base station may deliver configuration information of PUSCH resource(s) allocated to the terminal (or terminal group) for SDT in the CG scheme by using system information or a dedicated control message. Here, the dedicated control message may be a control message for configuring an RRC connection, a control message for releasing an RRC connection, or an RRC state transition control message (e.g., a control message for transition to the inactive state).

The CG configuration information for SDT (unless otherwise described below, CG configuration information refers to configuration information of PUSCH resource(s) allocated to the terminal (or terminal group) in the CG scheme) may be applied to or valid only for the base station configuring or signaling the CG configuration information. Accordingly, the base station may transmit CG configuration information of a neighboring base station to the terminal as system information. The CG configuration information of a neighboring base station included in the system information may be configured in form of a list consisting of CG configuration information of one or more neighboring base station(s).

When a terminal in the inactive state moves from the base station to which the received CG configuration information is applied to another base station, the terminal may obtain CG configuration information again from the new base station. To this end, the terminal may perform a procedure of acquiring the CG configuration information whenever entering a new base station, or may acquire CG configuration information of a new base station by using system information. Alternatively, the terminal may acquire CG configuration information of the corresponding base station in a step of performing a resume procedure (e.g., a resume procedure according to a condition for a resume procedure according to a timer-based or a routing area update condition) that satisfies an execution condition other than the purpose of SDT.

Even when the terminal in the inactive state enters a new base station as described above, if the CG configuration information is configured in form of a list of CG configuration information for one or more base station(s), the terminal may perform an SDT procedure by activating the CG configuration corresponding to the new base station in the list.

Alternatively, CG resource(s) applicable to a plurality of base stations may be configured for the terminal in the inactive state. To this end, the base station may configure an uplink, supplementary uplink (SUL), and/or BWP for CG resource(s) shared or partially overlapped with neighboring base stations. As described above, shared or partially overlapped CG resource(s) (e.g., UL, SUL, BWP, etc.) may be configured for SDT between a plurality of base stations. Hereinafter, CG resource(s) that are shared or partially overlapped between a plurality of base stations may be referred to as shared CG resource(s) or common CG resource(s). The shared CG configuration information delivered to the terminal may be configured to include an indicator or identifier information capable of determining whether the shared CG resource configured from a previous base station is valid (or whether the shared CG radio resource can be used) for the inactive terminal entering a new base station. When the shared CG radio resource(s) is configured to a plurality of base stations as described above, if the shared CG radio resource configured by a previous base station is valid, the inactive terminal entering a new base station may use the shared CG resource according to the CG configuration information to perform an SDT procedure. If the shared CG radio resource configured from a previous base station is not valid, the inactive terminal entering a new base station may acquire CG configuration information for the new base station by using a resume procedure or a separate CG configuration (or SDT request) procedure.

The base station may transmit CG configuration information to the terminal using system information or configure an uplink radio resource for triggering (or initiating) the CG configuration procedure to the terminal so that the inactive terminal entering the new base station acquires a CG resource. Therefore, the inactive terminal entering the new base station may trigger (or initiate) the CG configuration procedure by using the radio resource without transition to the connected state, transmit buffer state information (e.g., BSR MAC CE), or acquire a CG radio resource.

The terminal in the inactive state may perform a resume procedure or a separate CG configuration (or SDT request) procedure to initiate (or trigger) or request SDT using CG configuration information obtained from the base station. In this case, the terminal may transmit a control message for notifying initiation of SDT or requesting SDT to the base station by using the previously obtained CG configuration information and/or uplink CG resource. In this case, the control message may be configured to include one or more of the following information.
An identifier assigned to the terminal to identify the terminal in the inactive state (or a terminal identifier for SDT)
Information indicating whether one-time transmission (or one-shot transmission) is allowed
Information on the size (or number of messages) of SDT that can be performed as one-time transmission
Information on the size of SDT (or number of messages) that can be performed as being segmented
SDT data packet

The base station receiving the message notifying or requesting initiation (or triggering) of SDT from the terminal through the resume procedure or the separate CG configuration procedure for SDT may determine whether to allow the SDT and/or segmented transmission of the SDT to the terminal. When the SDT and/or segmented transmission of the SDT of the terminal is not allowable, the base station may instruct the terminal to transition to the connected state. In this case, the base station may transmit a control message of the base station (e.g., RRCSetup message or RRCResume message for transition to the connected state, etc.) to the terminal for a general resume procedure, not for the purpose of SDT. Upon receiving the control message for the general resume procedure, which is not for the purpose of SDT, from the base station, the terminal may transition to the connected state, and transmit the generated uplink data.

When the base station allows the SDT and/or the segmented transmission of the SDT of the terminal, the base station receiving the message notifying or requesting the initiation (or triggering) of the SDT from the terminal may transmit a response message for the resume procedure for SDT or the CG configuration procedure for SDT. Here, the response message may include one or more of a scheduling identifier for the corresponding terminal, frequency domain configuration information of uplink radio resources and/or CG resources for SDT, a transmission start time and/or transmission end time, an SDT period (or window, timer, counter), or time domain configuration information such as a transmission periodicity within a transmission period. In addition, the message notifying or requesting the initiation (or triggering) of the SDT may include one or more of a scheduling identifier, an SDT uplink resource index, or an SDT transmission period. Here, the SDT period (or window, timer, counter) may be a period for radio link management for performing the SDT or a period in which resource allocation (or scheduling) for the SDT is valid for the corresponding terminal (or group). Alternatively, the SDT period may be defined by a timer for determining whether the SDT has been successfully performed. The time domain configuration information may be configured in units of radio frames, subframes, slots, mini-slots, or symbols.

Using the uplink radio resource(s) for SDT allocated from the base station, the terminal may perform segmented transmission of the SDT or one-time SDT. After the SDT, the terminal may release the corresponding uplink radio resource(s) according to configuration of the base station. In case of the one-time SDT, the terminal may release the corresponding uplink radio resource after performing the corresponding SDT. In addition, in the step of transmitting the last segment of the SDT or performing the one-time SDT, the terminal may optionally transmit control information for requesting uplink radio resource configuration together. The terminal may transmit the uplink radio resource configuration/allocation request in form of a control field of uplink physical layer control information, a MAC control message, or an RRC control message. Here, the MAC control message may be configured in form of an LCID or MAC subheader indicating the uplink radio resource request, or configured in form of a MAC (sub)PDU including one or more of the above-described control information for SDT.

When the terminal in the inactive state performs the resume procedure or separate CG configuration procedure to obtain CG configuration information for a new base station, in the step of triggering or initiating the resume procedure or separate CG configuration procedure, the terminal may perform a procedure of explicitly releasing the CG resource(s) configured from the previous base station by transmitting control information indicating that the CG resource(s) configured from the previous base station have been released. Alternatively, the terminal may proceed with a procedure of releasing the CG resource(s) configured from the previous base station in an implicit manner without transmitting the explicit control information.

In order to support the implicit CG resource release method, the base station may transmit, to the terminal, indication information informing whether to allow the implicit CG resource release of the terminal in form of a control message or system information for configuring CG resource parameters. Alternatively, the base station may not allow the CG resource release function of the terminal by not setting a timer value for the CG resource release described below or setting it to an infinite value. Alternatively, the base station may deactivate or disable the operation according to the indication information indicating whether to allow the implicit CG resource release of the terminal or the operation according to the timer for CG resource release. In addition, the base station may selectively configure the CG configuration information by excluding (or disabling) some of lower parameters constituting the CG configuration information for a terminal having specific capabilities and/or properties, thereby implicitly determining or configuring whether to apply the CG resource release function.

Accordingly, when preconfigured condition(s) are satisfied, the terminal may perform a procedure for releasing the CG resource(s). The condition(s) for releasing the configured CG resource(s) may be as follows.
When the number of times that transmission using the configured CG resource(s) is omitted or not performed reaches a preset value (e.g., CG resource_Non_Tx_CNT)
When the next CG resource transmission does not occur or is not performed until a preset timer (e.g., CG resource release timer #1) expires
When a radio channel quality of a downlink channel (SSB, reference signal, BWP, configured beam (or TCI index)) of the base station, which corresponds to (or mapped) to the configured CG resource, does not satisfy a preset condition until a preset timer (e.g., CG resource release timer #2) expires
When the terminal entering a new base station acquires CG configuration information for the new base station by using the resume procedure or separate CG resource configuration procedure

The above-described CG resource release timer #1 and CG resource release timer #2 may be started after transmission using a CG resource is initiated (started) or may be started or restarted when transmission using a previous (or last) CG resource is performed. In addition, the CG resource release timer #1 and the CG resource release timer #2 may be configured to start/restart when a condition for determining whether the terminal is located at a cell boundary is satisfied. Here, the condition for determining whether the terminal is located at a cell boundary may use parameters such as the radio channel quality and/or position information of the terminal. The quality of the radio channel may be determined by whether or not the channel quality (e.g., RSRP, RSRQ, RSSI, SNR, SIR, etc.) of the serving cell and/or the neighboring cell satisfies a preconfigured condition. In addition, the position information of the terminal may be determined by information on a time for which a quality condition of the radio channel is satisfied and/or whether geographic position information of the terminal satisfies a preconfigured condition. Here, the geographic position information of the terminal may refer to position information of the terminal estimated (or measured) using a satellite for position measurement, a built-in sensor of the terminal, and/or a positioning reference signal (PRS).

The determination on whether transmission using a CG resource has been performed or the calculation (or counting) of the number of times that transmission using a CG resource has been omitted or not performed may include all of case(s) corresponding to the following conditions, or selectively include some of them.
When transmission using a CG resource is not performed because the radio channel quality condition for performing SDT is not satisfied
When transmission using a CG resource is not performed because there is no packet data of SDT to be performed
When transmission using a CG resource is not performed because the size condition of SDT to be performed is not satisfied
When transmission using a CG resource is not performed due to reasons such as BWP deactivation for the CG resource, deactivation of a transmission beam (or TCI index) for the CG resource, beam problem detection (BPD), and/or beam failure recovery (BFR)
When transmission using a CG resource is not performed for all configured beams in case that a plurality of beams (or TCI indices) are configured

In addition, when a plurality of CG resources are configured for SDT, the determination on whether transmission using a CG resource has been performed or the calculation (or counting) of the number of times that transmission using a CG resource has been omitted or not performed may be performed for each SSB and/or reference signal (e.g., DM-RS, CSI-RS, and/or other reference signals) mapped to the CG resource. That is, based on the result of determining whether the transmission using the corresponding CG resource has been performed, and/or the calculation (or counting) of the number of times the transmission using the corresponding CG resource has been omitted or not performed by using the SSB and/or reference signal mapped to the CG resource, it may be determined whether to release the corresponding CG resource.

When the CG resource release is determined according to the above-described CG resource release method, the release of the CG resource may be actually applied or performed when the following condition(s) are satisfied.
When a preconfigured time elapses (or a related timer (e.g., CG resource release application timer) expires) from a time when the terminal leaves the base station by which the CG resource determined to be released is configured or a time when the terminal enters a new base station

The CG resource release application timer may start when the terminal leaves the base station by which the CG resource determined to be released is configured, or when the terminal enters a new base station. In addition, the CG resource release application timer may be configured to (re)start when the above-described condition for determining whether the terminal is located at a cell boundary is satisfied.
When the terminal enters a base station with an area identifier different from an area identifier of the base station by which the CG resource determined to be released is configured

Here, the area identifier of the base station may refer to identifier information for identifying an area to which one or more base station(s) belong, such as a RAN area (or RAN-based notification area (RNA)) ID or a tracking area ID.

As described above, when a predetermined time elapses (or timer expires) from the time when the CG resource is determined to be released, or when the CG resource determined to be released is actually released when the terminal is out of a predetermined area, if the terminal re-enters the base station in which the CG resource determined to be released is configured before the corresponding timer expires, the terminal may reuse the CG resource without releasing the CG resource.

When the CG resource is released according to the above-described CG resource release method, the terminal may release the CG resource in an implicit method without transmitting control information notifying the release of the CG resource to the base station. However, when the base station and/or system indicates (or configures) the terminal to transmit control information notifying the release of the configured CG resource, the terminal may explicitly transmit a control message notifying the release of the configured CG resource to release the configured CG resource. In addition, when the terminal in the inactive state entering a new base station acquires a CG resource from the new base station based on the resume procedure, the new base station and/or the previous base station may release the CG resource configured by the previous base station or exchange information that the CG resource has been released in a step of transferring (or exchanging) of context information of the terminal.

In addition, when the CG resource is released according to the above-described CG resource release method, for the base station by which the released CG resource is configured, the terminal may perform the above-described RA procedure-based uplink SDT procedure or transmit a BSR MAC CE. In this case, the base station may determine that the configured CG resource has been released by receiving the RA message and/or the BSR MAC CE transmitted by the terminal for SDT.

In order for the terminal to determine CG resource release or to actually perform the CG resource release, the base station may include parameters in the CG configuration information, such as the CG resource_Non_Tx_CNT, CG resource release timer #1, CG resource release timer #2, CG resource release application timer for determining whether transmission using a CG resource has been performed or calculating (or counting) the number of times that transmission using a CG resource has been omitted or not performed, and deliver the CG configuration information to the terminal in form of a dedicated control message or system information. However, when applying the CG resource release function based on the timer described above, the values of the related timers (e.g., CG resource release timer #1, CG resource release timer #2, and/or CG resource release application timer, etc.) may not be set or may be set to infinite values, so that the CG resource release function of the terminal may not be applied, or may be deactivated or disabled. In particular, the CG release-related timer values may not be set or may be set to infinite values according to the capability and/or property of the terminal. Here, the capability of the terminal may refer to information constituting the capability level (or class) of the terminal supported by the system, including a reduced capability level terminal. In addition, the property of the terminal may refer to information constituting characteristics or reference conditions according to the type of the terminal (e.g., normal UE, IoT device, low cost device, wearable device, etc.) and mobility of the terminal (e.g., fixed, low/medium/high stationary, etc.). The capability and/or property information of the terminal may be stored in a USIM of the terminal, and may be delivered to the base station through a control message for the terminal to perform registration in the network, a control message for (re)establishing or releasing a connection with the network (or base station), and/or control information transmitted by the terminal according to the request (or configuration) of the network (or base station) (e.g., UE assistance information message, UE capability information message, or UE report message).

If the terminal that has received CG configuration information from the previous base station does not apply the procedure for acquiring CG configuration information from the new base station, the terminal may perform SDT to the new base station by performing the RA procedure-based SDT procedure described above.

As another method, the CG configuration information of the system information transmitted by the base station may be configured for each area composed of one or more base station(s) (e.g., tracking area, RAN area (e.g., RAN-based Notification Area (RNA)). When the CG configuration information is commonly applied to one or more base station(s), the CG configuration information may be identified using an identifier for an area to which the corresponding CG configuration information is applied. As such the area identifier, a RAN area (or RNA) ID or a tracking area ID may be used, an identifier (e.g., system information area ID) indicating that system information is commonly applied to one or more base station(s) may be used, or a CG resource area ID indicating an area to which the CG configuration information is commonly applied to one or more base station(s) may be used. Therefore, even when the serving cell or camped cell of the terminal is changed, if the area identifier for CG configuration information of the new serving cell or camped cell is the same as the area identifier of the previous serving cell or camped cell, the terminal may perform SDT by using the existing CG configuration information without need to update or newly acquire CG configuration information. For example, if a base station on which the terminal in the inactive state or idle state is camping through a cell (re)selection procedure is a base station belonging to the same area as the previous base station, the terminal may perform SDT by using the existing CG configuration information. The above-described CG configuration information for SDT may be preconfigured or allocated for each terminal (or terminal group).

In addition, when CG configuration information is commonly applied to one or more base station(s), the corresponding CG configuration information may include an identifier for uniquely identifying a specific terminal or a specific terminal group in a corresponding area. That is, in an area identified by the above-described RAN area (or RAN-based notification area (RNA)) ID, tracking area ID, system information area ID, or CG area ID, an identifier (or an in-area terminal identifier) for indicating that the CG configuration information is uniquely allocated to the specific terminal or the specific terminal group may be used. Accordingly, the specific terminal or terminal group may perform SDT using the CG resource allocated (or configured) to the specific terminal or terminal group, and collision with another terminal or terminal group may be avoided. In this case, when the specific terminal or terminal group performs SDT by using the CG resource, the specific terminal or terminal group may perform the SDT by masking (at least a part of) the SDT packet with the identifier (or in-area terminal identifier) assigned to the terminal or terminal group, or perform the SDT by including the corresponding identifier in the SDT.

The above-described CG configuration information for SDT may be allocated to the terminal by using a control message in a connection setup step or a connection resume step, or a control message for state transition (or connection release).

The above-described CG configuration information for SDT may be configured or allocated by using a contention-based or contention-free uplink channel. The CG resource for SDT may be a channel (or radio resource) allocated to a terminal (or terminal group) existing (or located) in a service area that satisfies a preconfigured condition.

The above-described CG configuration information for SDT may include CG resource allocation information (a bit string and/or PUSCH for CG resource transmission), MCS information, HARQ configuration information, transmission timing, or information for CG resource mapping between base stations in the CG resource area. Here, the CG resource allocation information may include the identifier of the terminal or terminal group to which the CG resource is allocated (or configured), whether the CG resource is allocated one-time, whether the CG resource is repeatedly allocated, and/or the number of times that the CG resource is repeatedly allocated.

In addition, the CG resource allocation information may refer to allocation information of a physical layer radio resource (e.g., physical resource block (PRB)) constituting the CG resource in the time domain and/or the frequency domain. The CG resource allocation information may include an index of a subcarrier where the CG resource starts in the frequency domain (e.g., system bandwidth, BWP, or subcarrier, etc.) or an offset from a predetermined reference (e.g., a start point of subcarriers constituting a system bandwidth or a BWP), a BWP index of the CG resource, information on the number of subcarriers or subchannels of the CG resource, and the like. Here, the BWP index of the CG resource may be an indicator for identifying a BWP in which the CG resource is configured and/or a BWP configured for SDT. The base station may configure or designate one or more BWP(s) for SDT. When the BWP index is delivered to the terminal using system information or a control message for connection configuration, the BWP index information may be excluded from the CG resource allocation information. The CG resource allocation information may include an index of a start position of the CG resource (e.g., an index of a frame, subframe, slot, mini-slot, or symbol where the CG resource starts) in the time domain (e.g., frame, subframe, slot, mini-slot, symbol, etc.) and/or the length of the CG resource, CG resource allocation period, a period (duration, window, or timer) in which the allocated CG resource is valid, or transmission-possible period information. Here, the CG resource allocation period may be configured in units of radio frames, subframes, slots, mini-slots, or symbols. In addition, the CG resource allocation period may be indicated by a frame and/or subframe in which the CG resource is transmitted, which is determined based on a modulo operation using the identifier of the terminal (e.g., IMSI, TMSI, S-TMSI, ResumeID, I-RNTI, C-RNTI, or other terminal identifiers) and/or a system frame number (SFN). A start point of slots, mini-slots, or symbols in the corresponding frame and/or subframe may be indicated by using offset information or offset information for the position where the CG resource starts.

In addition, a date and time (e.g., year/month/day/time) when SDT is required may be specified, or a section for the date and time when SDT is required may be designated. In this case, the CG resource for SDT may be configured on a specific month every year and/or on a specific date (or date range) every month. Alternatively, the CG resource for SDT may be configured at a specific time (or time range) of a specified year, month, and day. The specific date and time may be configured based on time information such as a UTC, GPS, or the like.

The MCS information represents information on a modulation scheme and code rate applied when performing SDT using the CG resource. The MCS information may be configured in form of a list or range having one or more MCS values. The terminal may select an MCS value that satisfies a condition from the MCS list (or range) according to the size of the SDT to be performed and/or the measurement result of the channel quality (e.g., CSI level, RSRP, RSRQ, etc.). When the terminal is configured to perform the SDT by selecting an MCS value, or when the base station does not deliver information on the MCS to be applied to the CG resource to the terminal, the terminal may transmit information (e.g., CG resource MCS indicator) on the MCS applied to the CG resource for SDT by including it in the SDT. The CG resource MCS indicator transmitted by the terminal may be configured in form of one or more bits, and may be configured and transmitted as a control parameter of a fixed format in a specific radio resource region of the CG resource. Accordingly, the base station may acquire information on the MCS applied to the SDT based on the CG resource MCS indicator received from the terminal, and perform demodulation and decoding operations for receiving the SDT.

In addition, the transmission timing information may refer to a system frame number (SFN) of the CG resource for SDT, index of the frame/subframe/slot/mini-slot/symbol, offset information for the SFN/frame/subframe/slot/mini-slot/symbol, etc. that can be used for estimating a transmission time (or timing), a time window value, or the like. The transmission timing information may include a start point where the CG resource starts in the time domain (e.g., frame, sub-frame, slot, or mini-slot, symbol, etc.) or information on an offset from a predetermined reference (e.g., a time reference point configured with an SFN or an index of frame/subframe, etc.). That is, the offset information may be offset information (e.g., in units of radio frames, subframes, slots, mini-slots, or symbols) from a start point of the CG resource allocation period or a reference point of the SFN.

In addition, the HARQ configuration information may include information indicating whether a HARQ function is supported for the SDT and/or whether repetitive transmission is applied to the SDT, the number of repetitions, configuration information of the CG resource to which repetitive transmission is applied, information on a time period to which the repetitive transmission is applied, or the like.

In addition, the information for CG resource mapping between the base stations in the CG resource area (hereinafter, CG resource mapping information) may refer to information for mapping CG resource(s) between base stations belonging to the same area when the CG configuration includes information on shared CG resource(s) commonly applied to one or more base station(s). For example, the mapping information may, even when different numerologies are applied to the base stations belonging to the area in which the same CG configuration information is applied (or, the area to which the CG configuration information having the same area identifier is applied), refer to information for the terminal to recognize a CG resource and/or a shared CG resource of a new base station according to the CG configuration information. Therefore, the mapping information may include offset information or information on a conversion mapping rule between different numerologies, which is used for acquiring CG configuration information to be actually applied to each of the base stations to which numerologies different with respect to transmission frequency/bandwidth, BWP configuration, subcarrier spacing, symbol length, or the like are applied. For example, when a BWP in which the CG resource obtained from the previous base station is configured and a BWP of a new base station are different in subcarrier spacing, slot/mini-slot configuration, or symbol configuration, the mapping information may include information on a mapping rule for determining a CG resource for each base station (or BWP), an index of the BWP in which the CG resource is configured, and/or mapping information.

In addition, for beam management (or selection) according to application of a beamforming technique, the CG configuration information may include information indicating a mapping relationship between a beam through the SSB and/or reference signal (e.g., DM-RS, CSI-RS, and/or other reference signal) is transmitted and a preamble (or pattern/sequence of a reference signal) radio resource for the CG resource. When the CG resource is composed of only a PUSCH without a preamble (or pattern/sequence of a reference signal), the CG configuration information may include information indicating a mapping relationship between a beam through the SSB and/or reference signal (e.g., DM-RS, CSI-RS, and/or other reference signal) is transmitted and a PUSCH radio resource.

When the terminal performs SDT by using the CG configuration information, the terminal may perform SDT when the size condition of the SDT to be performed and/or the channel quality condition (e.g., condition configured with parameters such as RSRP, RSRQ, CSI-RS, RSSI, or path loss) is satisfied. For example, if the size of the SDT to be performed satisfies a preconfigured allowable size condition, the terminal may select a CG resource mapped to (or corresponding to) an SSB and/or reference signal (e.g., DM-RS, CSI-RS, and/or other reference signal) satisfying the radio channel quality condition configured for SDT, and perform the SDT by using the selected CG resource. In this case, in the step of starting the SDT, the terminal may transmit information on an identifier for identifying a service of the SDT packet to be started or a logical channel identifier (LCID) for identifying a bearer (DRB or SRB) for the SDT packet to the base station.

In the case of allocating (or scheduling) an uplink radio resource for SDT by using a PDCCH in addition to the above-described CG configuration information, the corresponding PDCCH may include scheduling information for allocating the uplink radio resource for the SDT or information on a DCI format for the SDT (or the above-described IM DCI format).

In addition, when the CG resource is configured as including a preamble (or reference signal, pilot symbol, etc.) bit string (pattern) for CG resource, the CG configuration information may include mapping information between an index (or radio resource) of the bit string (pattern) of the preamble for CG resource and a PUSCH radio resource. Here, the index of the bit string (or sequence) of the preamble may refer to identification information capable of identifying the corresponding bit string (or sequence), such as an RA preamble index or a reference signal index. Such the preamble or reference signal may be designated in advance or configured to be located in a first or last symbol in the time domain of the corresponding uplink channel, located in a specific subcarrier in the frequency domain thereof, or mapped to RE(s) located in a specific time region and frequency region thereof.

The mapping information between the index (or radio resource) of the bit string (pattern) of the preamble for the CG resource and the PUSCH radio resource may refer to a mapping relationship between the preamble (or reference signal) radio resource for the CG resource and the PUSCH radio resource. For example, this may be information indicating a correspondence between the index of the preamble for the CG resource (or the index of the pattern/sequence of the reference signal) and the PUSCH resource through which the SDT is performed.

In addition, the bit string and PUSCH resource of the CG resource for SDT may be composed of one PRB resource or a plurality of PRB resources using consecutive radio resources, or composed of PRB resources spaced apart in the frequency domain or the time domain. The terminal performing the SDT may perform the SDT to the base station by using the PRB resource(s) of the CG resource preconfigured or allocated by the base station as described above.

When the terminal performs uplink SDT by using a CG resource, information indicating whether the SDT is performed as segmented (or information indicating whether the SDT is performed as one-time transmission) may be delivered together. Depending on whether the SDT is performed as segmented, the terminal may transmit a separate control message (e.g., MAC layer and/or RRC layer control message) in addition to the SDT. For example, when the SDT is performed as segmented (e.g., when two or more SDTs are performed through different time and/or frequency uplink radio resources), the terminal may deliver one or more among uplink radio resource request information for the segmented SDTs and/or the size of the uplink SDT (e.g., the size of the MAC PDU or RRC message, etc.), the number of messages for the uplink SDT (e.g., the number of the MAC PDUs or RRC messages, etc.), uplink buffer size information (e.g., BSR), a control message for connection configuration request, indication information indicating whether the size of the uplink SDT satisfies a preconfigured condition, information such as a radio channel measurement result, or a desired operation state of the terminal after completion of the SDT. When the control information is transmitted as a MAC layer message, whether the corresponding control information exists and/or value(s) (or configuration parameter range(s)) of the control information may be delivered in form of a MAC (sub)header or a MAC (sub)PDU. For this, a separate logical channel identifier (LCID) may be configured.

When it is determined that segmented transmission is applied based on the control information received from the terminal, the base station may allocate CG resources or uplink radio resources for the segmented transmission of the SDT to the terminal. In this case, frequency-domain configuration information of uplink radio resources and/or CG resources for SDT and time-domain configuration information such as a transmission start time and/or transmission end time, an SDT period (or window, timer, counter), or a transmission periodicity within the transmission period may be delivered to the terminal. The time-domain configuration information may be configured in units of radio frames, subframes, slots, mini-slots, or symbols.

By using the CG resource(s) and/or uplink radio resource(s) for SDT allocated from the base station, the terminal may perform the SDT by segmenting it or perform the SDT as one-time transmission. After performing the SDT, the terminal may release the corresponding CG resource(s) according to configuration of the base station. In the case of one-time transmission of the SDT, the terminal may release the corresponding CG resource. In addition, in the transmission step of the last segment of the SDT or the one-time transmission step of the SDT, the terminal may selectively transmit control information for requesting CG resource configuration together. The terminal may transmit the CG resource configuration/allocation request in form of a control field of uplink physical layer control information, a MAC control message, or an RRC control message. Here, the MAC control message may be configured in form of an LCID or MAC subheader indicating the CG resource request, or may be configured in form of a MAC (sub)PDU including one or more of the above-described control information for SDT.

In addition, when one or more of the following conditions are satisfied, the terminal may be restricted to perform the SDT according to the above-described SDT method using a CG resource or the above-described method described in FIG. 6 or 7.
When the size of the SDT is less than a predetermined size (e.g., several bytes or tens of bytes),
When the service type of the SDT (or QoS flow, traffic type/type, bearer type, etc.) satisfies a preconfigured condition,
When a logical channel identifier (LCID, logical channel ID), a bearer identifier (bearer ID), or a QoS flow ID, etc., corresponds to an identifier configured for SDT,
When an uplink transmission timing condition for SDT is satisfied,
When an SDT corresponds to an urgent service message, or,
When a measurement result of a radio channel satisfies a reference condition for SDT. Here, the reference condition may refer to a radio channel quality condition configured as a parameter such as RSRP, RSRQ, CSI-RS, RSSI, or path loss.

When the terminal determines the CG resource-based SDT, or when the CG resource-based SDT is triggered or initiated, the terminal may transmit to the base station a resume request message configured identically to the resume request message described in the RA procedure-based SDT method. The resume request message may be transmitted to the base station first when the terminal performs the CG resource-based SDT procedure. In addition, when data or a signaling message for an uplink SDT occurs, the base station and the terminal may not perform a new connection configuration step for the corresponding SDT or perform an operation procedure for state transition of the terminal, and the terminal may perform the SDT through an uplink channel (i.e., a random access channel or a CG resource preconfigured for SDT), as described above.

Configuration information such as time-domain or frequency-domain radio resource allocation information, MCS information, or HARQ retransmission information for a CG resource for SDT may be delivered to the terminal by using system information or a dedicated control message (e.g., a control transmitted delivered for state transition). That is, the configuration information for a CG resource for SDT may be signaled to the terminal within a service area satisfying conditions configured by the base station through system information, a MAC CE, or a physical layer control channel (or, PDCCH, DCI, UCI, etc.). The CG resource allocation information (such as time-domain or frequency-domain radio resource allocation information, MCS information, or HARQ retransmission information for the CG resource) transmitted through a physical layer control channel may be transmitted according to a preconfigured period and/or through a designated PDCCH transmission region (e.g., CORESET or search space). The corresponding physical layer control channel may be transmitted using a scheduling identifier allocated to a specific terminal or a specific terminal group, or allocated for transmission of the CG resource configuration information.

In addition, a radio resource for the above-described CG resource may be limited only to a resource of a BWP that is previously designated or configured. In this case, the CG resource configuration information may include a BWP index indicating the corresponding BWP. When a CG resource for SDT is configured using a default BWP, an initial BWP, and/or a CG resource-dedicated BWP at a system level, the CG resource configuration information may not include the BWP index. When a CG resource-dedicated BWP is configured, the base station may transmit CG resource-dedicated BWP configuration information to the terminal using system information or a dedicated control message.

In addition, when a CG resource for SDT is configured in an uplink BWP other than an initial uplink BWP, the corresponding BWP may be configured to have the same properties as the initial BWP. When a CG resource is configured in a UL/SUL BWP other than the initial uplink BWP, a BWP in which the terminal in the inactive state receives a paging message, system information change notification, system information (e.g., SI, SIB, posSIB, etc.), or MBS services may vary according to the capability of the terminal.

Case1: When the terminal in the inactive state can receive only in one downlink BWP

The terminal should be able to receive a paging message, system information change notification, system information (e.g., SI, SIB, posSIB, etc.), or MBS services through a DL BWP corresponding to (or mapped) to the UL/SUL BWP in which the CG resource is configured. Alternatively, the DL BWP corresponding to (or mapped) to the UL/SUL BWP in which the CG resource is configured should be configured as an initial BWP.

Case2: When the terminal in the inactive state can receive in two or more downlink BWPs

The terminal may receive a paging message, system information change notification, system information (e.g., SI, SIB, posSIB, etc.), or MBS services through an initial BWP other than a DL BWP corresponding to (or mapped) to the UL/SUL BWP in which the CG resource is configured. Alternatively, the terminal may receive a control message for SDT or feedback control information through a DL BWP corresponding to (or mapped) to the UL/SUL BWP in which the CG resource is configured.

In the above-described SDT, an encryption function according to a radio layer protocol may not be used or may be limitedly used in a radio section between the base station and the terminal. For example, an encryption function using an encryption key may not be applied, and only a function (e.g., integrity protection) to check integrity of a transmitted message may be applied.

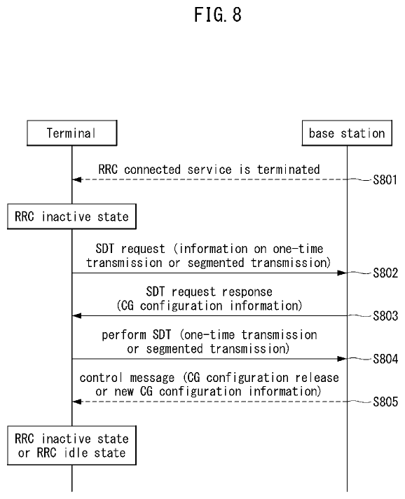

FIG. 8 is a sequence chart illustrating an SDT method based on an RA procedure and/or a CG resource.

Referring to FIG. 8, the terminal may transition to the RRC inactive state after terminating the service in the RRC connected state with the base station (S801). In this case, the terminal may receive a part (or all) of the above-described CG configuration information by using an RRC connection release message. In the RRC inactive state, the terminal in which SDT data occurs may request SDT from the base station through a resume procedure for SDT or a separate SDT request procedure (S802). The step S802 may be performed by using the above-described RA procedure (2-step or 4-step RA procedure) or by transmitting an SDT request message requesting SDT based on a CG resource. That is, the terminal may receive CG configuration information for SDT in the step S801, and when an SDT execution condition is satisfied, the terminal may request SDT from the base station based on a CG resource according to the CG configuration information. If the CG configuration information for SDT is not received in the step S801 or if the SDT execution condition is not satisfied according to the received CG configuration information, the terminal may request SDT based on the RA procedure. When the step S802 is performed using the RA procedure, the step S802 may be performed by transmission of RA-MAG1 and RA-MSG3 of the 4-step RA procedure or transmission of RA MSG-A of the 2-step RA procedure. When the step S802 is performed based on a CG resource, the SDT request message transmitted in the step S802 may be an uplink message transmitted for the first time by using a CG resource. In this case, the terminal may transmit information indicating whether SDT is performed as segmented transmission (or whether SDT is performed as one-time transmission) together with the SDT request message. When the step S802 is performed based on the RA procedure, the information indicating whether the SDT is performed as segmented transmission (or whether the SDT is performed as one-time transmission) may be expressed by an RA cause value. For example, an RA cause value for requesting one-time SDT and an RA cause value for requesting one or more SDTs may be configured separately. In addition, when the terminal requests one-time SDT, the terminal may transmit the RA cause value indicating one-time SDT, and when the terminal requests segmented SDT, the terminal may transmit the RA cause value indicating one or more SDTs.

Upon receiving the SDT request through the step S802, the base station may transmit an SDT request response message indicating whether to approve the SDT request to the terminal (S803). When the step S802 is performed based on the RA procedure, the step S802 may be performed by transmission of RA-MAG2 and RA-MSG4 of the 4-step RA procedure or transmission of RA MSG-B of the 2-step RA procedure. In addition, when the step S802 is performed based on a CG resource, the SDT request response message transmitted in the step S803 may be a downlink message transmitted for the first time by the base station in response to the first uplink transmission. The message of the step S803 may be configured based on an RRC connection release message or may be configured in form of a separate control message for the SDT request response and transmitted to the terminal. In this case, the base station may transmit, to the terminal, uplink scheduling information for the SDT of the terminal (e.g., uplink radio resource allocation information, scheduling identifier (C-RNTI), power control information (or indicator), control information indicating whether segmented transmission is allowed, information allowing or indicating one-time transmission, and/or new CG configuration information (or updated CG configuration information).

Upon receiving the SDT request response message from the base station, the terminal may perform the SDT operation according to the configuration (or indication) of the base station received in the step S803 (S804). When one-time transmission is allowed (or indicated), the terminal may transmit SDT data only once and terminate the SDT operation. On the other hand, when segmented transmission is allowed (or indicated), the terminal may perform one or more SDT operations by segmenting the SDT data according to the configuration (or scheduling) of the base station. The scheduling information for uplink radio resources for the step S804 may be transmitted using the scheduling identifier assigned to the terminal in the step S803. The base station may transmit information on candidate transmission beam(s) (or TCI state identifier(s)) that the terminal can select in the step S804 by including the information in the scheduling information. The information on the candidate transmission beam(s) (or TCI state identifier(s)) may be delivered to the terminal as being configured as field information included in a PDCCH (or DCI), or may be delivered to the terminal as being configured in form of a MAC CE.

According to the scheduling information of the uplink radio resources for the step S804, when transmitting the SDT data in the step S804, the terminal may select a transmission beam (or TCI state identifier) based on SS/PBCH block(s), and perform the transmission using the selected transmission beam (or TCI state identifier). When the SDT operation is performed based on the RA procedure, the uplink transmission in the step S804 may be performed using a transmission beam (or TCI state identifier) selected in the RA-MSG3 transmission of the 4-step RA procedure or the RA MSG-A transmission of the 2-step RA procedure.

In the CG resource-based SDT operation, if more than one segmented transmission is required instead of one-time transmission, the uplink transmission of the step S804 may be performed continuously using the transmission beam (or TCI state identifier) selected in the first CG uplink resource transmission. Accordingly, the base station may configure CG resources corresponding to a plurality of SS/PBCH resources to the terminal, and the terminal may need to perform the first CG uplink transmission operation by selecting an uplink transmission beam corresponding to an optimal (or best) SS/PBCH that meets the CG configuration condition for SDT.

Alternatively, the terminal may perform the SDT operation by selecting an uplink transmission beam (or TCI state identifier) corresponding to an SS/PBCH that meets the CG configuration condition whenever the uplink transmission of the step S804 is performed. In this case, if there is no uplink transmission beam (or TCI state identifier) corresponding to the SS/PBCH that meets the CG configuration condition, the terminal may omit the SDT transmission and re-attempt the SDT transmission in the next CG resource.

In addition, if the change of the transmission beam (or TCI state identifier) is allowed at the time when the terminal transmits the SDT data in the step S804, the terminal may select a transmission beam (or TCI state identifier) by using the information on the candidate transmission beam(s) (or TCI state identifier(s)) included in the scheduling information for the step S804 transmitted by the base station. In addition, when transmitting the SDT data, the terminal may transmit information on a candidate transmission beam (or TCI state identifier) to be used in the next uplink transmission together. In this case, the information on the candidate transmission beam (or TCI state identifier) may be configured in form of a MAC CE. In addition, the MAC CE may include index information (or index list) of specific transmission beam(s) (or TCI state identifier(s)). Alternatively, the MAC CE may include information indicating a bit corresponding to a specific beam among beams (or TCI state identifiers) configured in a bitmap format.

In addition, when transmitting the SDT data in the step S804, the terminal may transmit radio channel quality measurement result information (or channel quality report information) together. In this case, a radio channel quality may mean a measurement result for an SS/PBCH and/or downlink reference signal mapped to the CG resource or the RA resource in the SDT execution procedure (or operation). The channel quality report information may be transmitted by being multiplexed with the SDT packet on a PUSCH other than a PUCCH when the terminal transmits the SDT packet, regardless of a request of the base station. In this case, the channel quality report information may be configured as a MAC CE or in a coding scheme (or indexing scheme) of a physical layer.

In addition, HARQ feedback information indicating whether the uplink SDT data transmitted by the terminal has been successfully received may be signaled from the base station to the terminal using a downlink physical layer control channel (PDCCH or DCI). The HARQ feedback information transmitted through the physical layer control channel may be signaled to the terminal may include a HARQ process ID together with ACK or NACK information. The terminal that has received the NACK feedback from the base station or has not received the HARQ feedback may retransmit the SDT data by using the next CG resource or an uplink resource dynamically allocated from the base station. The base station may transmit scheduling information (e.g., MCS level) for the retransmission to the terminal by using a PDCCH (or DCI). Alternatively, the base station may preconfigure a pattern of redundancy versions (RVs) that the terminal can use for the retransmissions to the terminal without transmitting the scheduling information (e.g., PDCCH or DCI) for every retransmission.

Upon receiving the SDT data (in case of segmented transmission, the last packet of the SDT data) from the terminal, the base station may optionally transmit a control message according to the completion of the SDT operation (S805). That is, the transmission of the control message in the step S805 may be omitted. When the control message of the step S805 is transmitted, the base station may indicate release of the CG configuration or transmit new CG configuration information to the terminal. In addition, a control message indicating transition to the RRC idle state may be transmitted to the terminal.

In addition, when the base station transmits a downlink physical layer control channel (or PDCCH) to support the SDT function in the above-described SDT method based on RA procedure and/or CG resource, a PDCCH (or DCI) transmission region (e.g., CORESET or search space) for supporting the SDT function may be configured to be separated from the existing CORESET or search space for other purposes. Accordingly, the terminal may receive a PDCCH (or DCI) for supporting the SDT function by monitoring a designated (or configured) CORESET or search space for supporting the SDT function.

In addition, in the above-described SDT method based on RA procedure and/or CG resource, when the condition(s) of using a CG resource configured for SDT are not satisfied, the SDT using a CG resource may be restricted even for the terminal to which a CG resource for SDT is configured. Here, the condition(s) of using a CG resource may be configured as a combination of one or more among a condition that an area identifier for the above-described CG configuration information is the same as an area identifier of a base station of a service area in which the terminal currently exists, uplink transmission timing condition for SDT, a condition that a measurement result of a radio channel satisfies a reference for SDT, and a condition that uplink physical layer synchronization is maintained. When the preconfigured condition(s) of using a CG resource are not satisfied, the terminal may perform SDT by using the above-described RA procedure for SDT, not a CG resource for SDT.

After completing SDT based on the above-described RA procedure and/or CG resource, the terminal may maintain the inactive state or transition to the idle state according to determination (or control) of the base station and/or a request of the terminal. When the terminal transitions to the idle state, the terminal may transition to the idle state without receiving the above-described CG configuration information for SDT. In the case that the terminal maintains the inactive state, the terminal may perform a CG resource-based SDT procedure when a next SDT packet occurs by using newly configured CG configuration information or the existing CG configuration information stored in the terminal.

The above-described SDT method based on the RA procedure and/or CG resource may be applied to a terminal in the connected state to which uplink resources are not allocated. That is, when the terminal in the connected state does not have allocated uplink radio resources or does not have a valid scheduling request (SR) resource for requesting an uplink resource, the terminal in the connected state may perform uplink SDT by using the RA procedure or CG resource according to the above-described method and procedure. In the above-described SDT based on the RA procedure and/or CG resource, information on configuration parameters such as an SDT period (or window, timer, counter), information indicating whether one-time transmission (or one-shot transmission) is allowed and/or information on the size (or number of messages) of SDT that can be performed as one-time transmission, or information on the size (or number of messages) of SDT that can be performed as segmented may be delivered to the terminal through system information and/or an RRC control message.

During one-time transmission of SDT or segmented transmission of SDT using two or more segments, the terminal may not perform a radio link failure (RLF) detection, radio link monitoring (RLM), beam failure detection and recovery, and the like. If SDT is not completed within the SDT period (or window, timer, counter), it may be determined that the SDT has failed.

According to a size threshold (or condition value) of uplink SDT configured for SDT and/or a subsequent data transmission method for segmented transmission of SDT, the terminal may use one or more uplink resources to perform the SDT. Accordingly, a time from the SDT request to the completion of the SDT may be longer than a time required for the existing procedure for resuming a radio link (e.g., resume procedure of the 3GPP LTE/NR system). Accordingly, at least one of the following methods may be considered as a timer-based method of managing (or detecting) a failure of SDT.
Method 1: Method of managing (or detecting) an SDT failure based on an SDT timer
Method 2: Method of managing (or detecting) an SDT failure based on the legacy radio link resume timer (e.g., T319 timer of the 3GPP LTE/NR system) and an SDT timer

Method 1 is a method of managing (or detecting) whether SDT has failed by using one SDT timer from a transmission time of the SDT request message until the SDT is completed. The SDT timer may be started or restarted whenever the terminal performs uplink transmission in order to support (or perform) the SDT function. That is, the SDT timer may be started or restarted whenever the terminal is performing the RA procedure or whenever the terminal performs transmission using a CG resource and/or uplink resource scheduled by the base station. When the SDT and/or each uplink transmission for the SDT is not completed until the SDT timer expires, the terminal and/or the base station may determine an SDT failure.

For Method 2, an SDT procedure may be divided into an SDT initiation step and an SDT execution step. The SDT initiation step may refer to a period from a time at which an SDT request message (or, RA MSG3 or RA MSG-A according to the RA procedure) is transmitted to a time at which a response message (or, RA MSG4 or RA MSG-B according to the RA procedure) to the SDT request message is received from the base station. The SDT execution step may refer to a step in which the terminal transmits an SDT packet by using an uplink radio resource. In the SDT initiation step, the terminal may manage (or detect) whether the SDT has failed by using the legacy radio link resume timer (e.g., T319 timer). Therefore, the resume timer may start at the time at which the SDT request message (or, RA MSG3 or RA MSG-A according to the RA procedure) is transmitted, and may stop at the time at which the response message (or, RA MSG4 or RA MSG-B according to the RA procedure) to the SDT request message is received from the base station. If the response message is not received until the radio link resume timer expires, the terminal and/or the base station may determine an SDT failure.

In the SDT execution step, the terminal may manage (or detect) whether the SDT has failed by using the SDT timer (or SDT instantaneous timer). The SDT timer (or SDT instantaneous timer) may be started or restarted whenever the terminal performs transmission through an uplink radio resource in order to support (or perform) the SDT function. That is, the SDT timer (or SDT instantaneous timer) may be started or restarted every time the terminal transmits an SDT packet by using a CG resource and/or an uplink resource scheduled from the base station. When the transmission of the SDT packet is not completed until the SDT timer (or SDT instantaneous timer) expires, the terminal and/or the base station may determine an SDT failure. Therefore, in Method 2, by using the legacy radio link resume timer (e.g., T319 timer) and the SDT timer (or SDT instantaneous timer) for each step, it may be managed (or detected) whether or not the SDT has failed.

If the SDT has failed, after a preconfigured time period (or timer), in which the reattempt of the SDT is restricted after the SDT, ends, the terminal in the idle state or the inactive state may request the SDT again or reattempt the SDT. Information on the time period (or timer) in which the reattempt of the SDT is restricted may be delivered to the terminal through system information and/or a control message. Alternatively, when the SDT finally fails in the idle state or in the inactive state, the terminal may transition to the connected state and transmit the packet of the corresponding SDT. In this case, before or when the preconfigured SDT period (or window, timer, counter) ends or when the end of the SDT period is recognized, the base station may indicate the terminal to transition to the connected state, or the terminal may transmit a control message requesting transition to the connected state to the base station or perform a connection configuration procedure such as an RA procedure.

Here, the counter (or timer) that manages the SDT period may be started (or restarted) when the message requesting SDT using the above-described RA procedure or CG resource is transmitted, when the SDT is performed, at each transmission time when two or more SDTs are performed, or when an uplink resource for SDT is allocated. In addition, the counter (or timer) that manages the SDT period may be stopped when the terminal receives a response message to the message requesting the SDT (e.g., a response message for allowing, withholding, or rejecting the SDT, or a message indicating a state transition for transmission of the corresponding data transmission).

In this case, a mapping relationship between the CG resource for SDT and the scheduling identifier (e.g., C-RNTI, CG-RNTI, CG resource-RNTI, etc.) and/or DMRS configuration information assigned to the corresponding terminal (or terminal group) may be established. Here, the DMRS configuration information may refer to radio resources for DMRS transmission, a DMRS sequence, or a cyclic shift parameter. Configuration information on the mapping relationship may be delivered to the terminal using system information or a control message.

After the above-described SDT operation is initiated or triggered, a non-SDT packet may occur in the terminal. When the SDT operation is not initiated, the terminal in the inactive state may transition to the connected state by using an RRC restart (or resume) procedure, and transmit the non-SDT packet (e.g., data/message of a non-SDT DRB or SRB). However, after the SDT operation is initiated, the terminal may be restricted not to perform the RRC restart (or resume) procedure. Accordingly, a transmission method for the non-SDT packet occurring after the SDT function is initiated is required. A combination of one or more of the following may be performed for transmission of the non-SDT packet occurring in the terminal after the SDT is initiated using the above-described RA procedure or CG resource.

Method 1: The terminal may perform transmission of the non-SDT packet based on RRC restart (or resume) after completing the SDT already initiated.

Method 2: The terminal may perform transmission of the non-SDT packet with an uplink resource obtained through execution of the initiated SDT.

Method 3: The terminal may perform early termination or suspension of the initiated SDT and transmission of the non-SDT packet.

Method 4: The terminal may perform a non-SDT procedure in parallel with the initiated SDT.

In addition, a condition(s) for determining whether to perform a non-SDT operation after SDT is initiated may be preconfigured. That is, when one or more of the following conditions for determining whether to perform the non-SDT operation are satisfied, the terminal may be configured to perform the non-SDT operation by selecting one of the above-described Methods 1 to 4.
when a predetermined time elapses from a start time of the initiated SDT operation,
when a time required until the initiated SDT operation is completed (or an SDT timer according to the initiated SDT operation expires) is longer than a predetermined threshold,
when a quality of a radio channel deteriorates below a reference condition after the SDT operation is initiated,
when a condition for allowing the non-SDT operation to be performed during the SDT operation is satisfied

In case of Method 1, when the SDT operation using the above-described RA procedure or CG resource is completed, the terminal may perform a procedure of transitioning to the connected state for transmission of the non-SDT packet. For transition to the connected state, the terminal may transmit a control message requesting RRC restart or RRC connection re-establishment to the base station. The terminal transitioned to the connected state by the RRC restart or RRC connection re-establishment request may transmit the non-SDT packet by using an uplink resource scheduled by the base station.

In case of Method 2, the terminal may transmit to the base station information indicating that the non-SDT packet has occurred through an uplink radio resource obtained during the SDT procedure using the above-described RA procedure or CG resource. That is, the terminal may configure a control message informing arrival of a non-SDT DRB packet and/or generation of an SRB for non-SDT, and transmit the control message to the base station by using an uplink resource or a CG resource allocated (or scheduled) according to the above-described RA procedure for SDT. In this case, the terminal may configure control information informing of the arrival and/or generation of the non-SDT packet (hereinafter, ‘non-SDT indication information’) in one of the following schemes and transmit it to the base station.
MAC layer control message (or MAC CE) transmission: MAC subheader, MAC (sub)PDU
RRC layer control message transmission: common control channel (CCCH), dedicated control channel (DCCH)

Here, when the MAC layer control message (or MAC CE) is used, the non-SDT indication information may be configured in form of a MAC subheader, a MAC sub-PDU, and/or a MAC PDU. The non-SDT indication information may consist of one or more bits. When the non-SDT indication information consists of one bit, the occurrence of the non-SDT packet (i.e., whether the non-SDT packet arrives and/or is generated) may be indicated using a corresponding bit. When the non-SDT indication information consists of a plurality of bits, non-SDT type information as well as the arrival and/or generation of the non-SDT packet may be indicated together. The non-SDT type information may be information capable of distinguishing or determining a service type, urgency, bearer classification, or the size of the corresponding non-SDT packet.

Therefore, when recognizing a non-SDT packet after initiating SDT based on the RA procedure or CG resource, the terminal may transmit non-SDT indication information to the base station in form of a MAC CE by using an uplink resource for SDT. The non-SDT indication information transmitted in form of a MAC CE may be transmitted as being multiplexed with an SDT packet based on a preset priority or a logical channel priority (LCP), or may be transmitted alone. In addition, a logical channel ID (LCID) for distinguishing the non-SDT indication information transmitted in form of a MAC CE may be separately configured.

When using the RRC layer control message, the non-SDT indication information may be transmitted as a common control channel (CCCH) or dedicated control channel (DCCH) message. When using the RRC layer control message, the non-SDT indication information may be configured including an identifier for distinguishing the corresponding terminal, a cause value information indicating that it is a CCCH or DCCH message for non-SDT, and/or the like.

The CCCH or DCCH message carrying the non-SDT indication information may be transmitted by being multiplexed with a DRB and/or SRB for SDT or transmitted alone. When multiplexed with a DRB and/or SRB for SDT, the CCCH or DCCH message carrying the non-SDT indication information may be multiplexed according to a preset priority or condition.

In case of Method 3, when one or more of the above-described non-SDT execution conditions are satisfied or a separately defined condition for performing the non-SDT operation after the SDT is initiated is satisfied, the terminal may early terminate (or suspend) the initiated SDT, and perform the non-SDT operation. For the non-SDT operation, the base station may transmit information on whether to allow the terminal in the inactive state to early terminate (or suspend) the initiated SDT, and information on condition(s) (or configuration(s)) for early SDT termination (or suspension) to the terminal by using system information, an RRC connection release message, or the like.

Accordingly, when the preset condition(s) are satisfied, the terminal in the inactive state may terminate the initiated SDT. However, even though the SDT is terminated, the terminal may transmit an uplink control message and/or a data packet for the non-SDT operation by using an uplink radio resource obtained during the SDT operation. That is, the non-SDT procedure may be performed using the MAC layer control message and/or the RRC layer control message in the above-mentioned Method 2. However, the procedure of multiplexing with the SDT in the MAC layer and the RRC layer of the above-mentioned Method 2 may be unnecessary.

If the SDT is not completed even after the non-SDT operation is triggered according to the above-described Method 2 or 3, the terminal may transmit SDT packet(s) remaining in a terminal buffer by using uplink radio resource(s) for the non-SDT operation. To this end, the base station may transmit to the terminal configuration information of a bearer for transmission of the packet(s) of the terminated or suspended SDT by including the configuration information in a downlink control message. Accordingly, the terminal may transmit the SDT packet(s) remaining in the transmission buffer by using radio resources for the SDT bearer configured (or scheduled) from the base station.

In case of Method 4, the non-SDT operation may be performed in parallel with the initiated SDT operation. That is, the terminal may transition to the connected state by performing an RRC restart (or resume) procedure for the non-SDT operation. When the transition to the connected state is completed, the terminal may transmit SDT packet(s) remaining in the terminal buffer, for which transmission has not been completed, in the connected state.

In addition, the base station may configure a contention-free RA resource (e.g., step 2 RA and/or step 4 RA) to the terminal in the inactive state, and may allow the terminal to transmit the above-described non-SDT indication information by using the contention-free RA resource. That is, when the terminal in the inactive state recognizing the non-SDT packet after initiating the SDT cannot transmit the non-SDT indication information using an uplink resource obtained through the SDT procedure, the terminal may transmit the non-SDT indication information by using the contention-free RA resource configured from the serving base station. In this case, the terminal may configure the non-SDT indication information configured in form of a MAC CE, CCCH message, or DCCH message without identifier information for distinguishing the terminal, and transmit it to the base station.

In addition, the base station receiving the non-SDT indication information transmitted by the terminal in the inactive state that initiated the SDT according to the above-described method may instruct the corresponding terminal to terminate or suspend the SDT operation in progress and transition to the connected state. A control message for indicating the transition to the connected state may be delivered to the terminal in form of an RRC (re)configuration message or an RRC restart message. In this case, the base station may transmit to the terminal configuration information of a bearer for transmission of the packet(s) of the terminated or suspended SDT by including the configuration information in the control message indicating the transition to the connected state. Accordingly, the terminal that has transitioned to the connected state according to the indication of the base station may transmit SDT packet(s) remaining in the transmission buffer by using radio resource(s) for the SDT bearer configured (or scheduled) by the base station.

In the present disclosure, the radio channel quality may be a channel state indicator (CSI), a received signal strength indicator (RSSI), a reference signal received power (RSRP), a reference signal received quality (RSRQ), or a signal to interference and noise ratio (SINR). With respect to the operation of the timer defined or described in the present disclosure, although operations such as start, stop, reset, restart, or expire of the defined timer are not separately described, they mean or include the operations of the corresponding timer or a counter for the corresponding timer.

In the present disclosure, the base station (or cell) may refer to a node B (NodeB), an evolved NodeB, a base transceiver station (BTS), a radio base station, a radio transceiver, an access point, an access node, a road side unit (RSU), a radio remote head (RRH), a transmission point (TP), a transmission and reception point (TRP), or a gNB. In addition, the base station (or, cell) may a CU node or a DU node to which the functional split is applied.

In the present disclosure, the terminal may refer to a UE, a terminal, an access terminal, a mobile terminal, a station, a subscriber station, a mobile station, a portable subscriber station, a node, a device), an Internet of Thing (IoT) device, or a mounted apparatus (e.g., a mounted module/device/terminal or an on-board device/terminal).

The exemplary embodiments of the present disclosure may be implemented as program instructions executable by a variety of computers and recorded on a computer-readable medium. The computer-readable medium may include a program instruction, a data file, a data structure, or a combination thereof. The program instructions recorded on the computer-readable medium may be designed and configured specifically for the present disclosure or can be publicly known and available to those who are skilled in the field of computer software.

Examples of the computer-readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the embodiments of the present disclosure, and vice versa.

While the embodiments of the present disclosure and their advantages have been described in detail, it should be understood that various changes, substitutions and alterations may be made herein without departing from the scope of the present disclosure.

What is claimed is:

1. An operation method for non-small data transmission (non-SDT), performed by a terminal, the operation method comprising:
initiating or triggering an SDT operation with a base station;
identifying occurrence of a non-SDT packet in a state in which the SDT operation is initiated or triggered;
determining whether a condition for performing transmission of the non-SDT packet is satisfied when the occurrence of the non-SDT packet is identified; and
in response to determining that the condition is satisfied, performing the transmission of the non-SDT packet.

2. The operation method according to claim 1, wherein the condition for performing transmission of the non-SDT packet is determined to be satisfied:
when a predetermined time elapses from a start time of the initiated or triggered SDT operation;
when a time required until the initiated or trigger SDT operation ends or an SDT timer according to the initiated or triggered SDT operation expires is longer than a predetermined threshold;
when a radio channel deteriorates below a reference condition after the SDT operation is initiated or triggered; or
when a condition for allowing the transmission of the non-SDT packet during the SDT operation is satisfied.

3. The operation method according to claim 1, wherein the performing of the transmission of the non-SDT packet comprises:
completing the initiated or triggered SDT operation;
transitioning to a connected state with the base station by performing a radio resource control (RRC) restart procedure or an RRC resume procedure with the base station; and
performing the transmission of the non-SDT packet by using an uplink resource allocated from the base station.

4. The operation method according to claim 1, wherein the performing of the transmission of the non-SDT packet comprises notifying the base station of the occurrence of the non-SDT packet by using an uplink resource obtained through the initiated or triggered SDT operation, wherein the uplink resource obtained through the initiated or triggered SDT operation is an uplink resource obtained by a random access (RA) procedure with the base station or a configured grant (CG) resource.

5. The operation method according to claim 4, wherein in the notifying the base station of the occurrence of the non-SDT packet, the terminal transmits non-SDT indication information to the base station through a medium access control (MAC) layer control message or RRC layer control message, the non-SDT indication information notifying the occurrence of the non-SDT packet.

6. The operation method according to claim 5, wherein when the non-SDT indication information is transmitted through a MAC control element (CE), the non-SDT indication information is transmitted by being multiplexed with the non-SDT packet or transmitted alone, and a logical channel identifier (LCID) for identifying the non-SDT indication information is configured.

7. The operation method according to claim 5, wherein when the non-SDT indication information is transmitted through an RRC layer control message, the non-SDT indication information is transmitted through a common control channel (CCCH) or a dedicated control channel (DCCH), and the non-SDT indication information includes an identifier of the terminal and a cause value indicating the transmission of the non-SDT packet.

8. The operation method according to claim 1, wherein the performing of the transmission of the non-SDT packet comprises:
early terminating or suspending the initiated or triggered SDT operation; and
performing the transmission of the non-SDT packet by using an uplink resource obtained in the initiated or triggered SDT operation.

9. The operation method according to claim 1, wherein the performing of the transmission of the non-SDT packet comprises:
transitioning to a connected state with the base station by performing an RRC restart procedure or an RRC resume procedure with the base station while performing the initiated or triggered SDT operation; and
after transitioning to the connected state, performing the initiated or triggered SDT operation and the transmission of the non-SDT packet together in the connected state.

10. An operation method for receiving a non-small data transmission (non-SDT) packet, performed by a base station, the operation method comprising:
initiating or triggering an SDT operation with a terminal;
identifying occurrence of a non-SDT packet in the terminal in a state in which the SDT operation is initiated or triggered;
determining whether a condition for performing reception of the non-SDT packet is satisfied when the occurrence of the non-SDT packet is identified; and
in response to determining that the condition is satisfied, performing the reception of the non-SDT packet.

11. The operation method according to claim 10, wherein the condition for performing reception of the non-SDT packet is determined to be satisfied:
when a predetermined time elapses from a start time of the initiated or triggered SDT operation;
when a time required until the initiated or trigger SDT operation ends or an SDT timer according to the initiated or triggered SDT operation expires is longer than a predetermined threshold;
when a radio channel deteriorates below a reference condition after the SDT operation is initiated or triggered; or
when a condition for allowing the transmission of the non-SDT packet during the SDT operation is satisfied.

12. The operation method according to claim 10, wherein the performing of the reception of the non-SDT packet comprises:
completing the initiated or triggered SDT operation;
transitioning the terminal to a connected state by performing a radio resource control (RRC) restart procedure or an RRC resume procedure with the terminal; and
performing the reception of the non-SDT packet by transmitting scheduling information of an uplink resource to the terminal.

13. The operation method according to claim 10, wherein the performing of the reception of the non-SDT packet comprises receiving, from the terminal, non-SDT indication information notifying the occurrence of the non-SDT packet by using an uplink resource allocated to the terminal through the initiated or triggered SDT operation, wherein the uplink resource allocated to the terminal through the initiated or triggered SDT operation is an uplink resource allocated to the terminal by a random access (RA) procedure or a configured grant (CG) resource.

14. The operation method according to claim 13, wherein the non-SDT indication information is received from the terminal through a medium access control (MAC) layer control message or radio resource control (RRC) layer control message.

15. The operation method according to claim 10, wherein the performing of the reception of the non-SDT packet comprises:
early terminating or suspending the initiated or triggered SDT operation; and
performing the reception of the non-SDT packet using an uplink resource allocated to the terminal in the initiated or triggered SDT operation.

16. The operation method according to claim 10, wherein the performing of the reception of the non-SDT packet comprises:
transitioning the terminal to a connected state by performing an RRC restart procedure or an RRC resume procedure with the terminal while performing the initiated or triggered SDT operation; and
after the terminal is transitioned to the connected state, performing the initiated or triggered SDT operation and the reception of the non-SDT packet together in the connected state.

17. A terminal for performing non-small data transmission (non-SDT), the terminal comprising:
a processor;
a memory electronically communicating with the processor; and
instructions executable by the processor, which are stored in the memory,
wherein when executed by the processor, the instructions cause the terminal to:
initiate or trigger an SDT operation with a base station;
identify occurrence of a non-SDT packet in a state in which the SDT operation is initiated or triggered;
determine whether a condition for performing transmission of the non-SDT packet is satisfied when the occurrence of the non-SDT packet is identified; and
in response to determining that the condition is satisfied, perform the transmission of the non-SDT packet.

18. The terminal according to claim 17, wherein the condition for performing transmission of the non-SDT packet is determined to be satisfied:
when a predetermined time elapses from a start time of the initiated or triggered SDT operation;
when a time required until the initiated or trigger SDT operation ends or an SDT timer according to the initiated or triggered SDT operation expires is longer than a predetermined threshold;
when a radio channel deteriorates below a reference condition after the SDT operation is initiated or triggered; or
when a condition for allowing the transmission of the non-SDT packet during the SDT operation is satisfied.

19. The terminal according to claim 17, wherein in the performing of the transmission of the non-SDT packet, the instructions further cause the terminal to transmit non-SDT indication information notifying the occurrence of the non-SDT packet to the base station by using an uplink resource obtained through the initiated or triggered SDT operation through a medium access control (MAC) layer control message or RRC layer control message, and the uplink resource obtained through the initiated or triggered SDT operation is an uplink resource obtained by a random access (RA) procedure with the base station or a configured grant (CG) resource.

20. The terminal according to claim 17, wherein in the performing of the transmission of the non-SDT packet, the instructions further cause the terminal to early terminate or suspend the initiated or triggered SDT operation; and perform the transmission of the non-SDT packet by using an uplink resource obtained in the initiated or triggered SDT operation.
